(19) United States
(12) Patent Application Publication
(10) Pub. No.: US 2022/0051195 A1
(43) Pub. Date: Feb. 17, 2022

(54) SERVICE PROVIDER ENGAGEMENT AND MANAGEMENT ENVIRONMENT

(71) Applicant: FixedASAP, LLC, Denver, CO (US)

(72) Inventor: Bradley Girard Apple, Denver, CO (US)

(21) Appl. No.: 17/403,739

(22) Filed: Aug. 16, 2021

Related U.S. Application Data
(60) Provisional application No. 63/066,812, filed on Aug. 17, 2020.

(51) Int. Cl. G06Q 10/10; G06Q 10/06; G06Q 20/10; G06Q 10/00

(52) U.S. Cl. CPC G06Q 10/1053; G06Q 10/20; G06Q 20/102; G06Q 10/06393

(57) ABSTRACT

Systems and methods are provided for service provider engagement and management environment. One embodiment is a system that includes a server with a controller configured to receive a selection by the customer device indicating, from among the list of one or more replying maintenance providers, a selected maintenance provider for performing the service request. The controller is also configured to generate a booking request for the selected maintenance provider, and in response to receiving acceptance of the booking request by the selected maintenance provider, to provide customer contact information to the selected maintenance provider to facilitate performance of the service request.

### RELATED APPLICATIONS

This non-provisional application claims priority to U.S. provisional application 63/066,812, which was filed on Aug. 17, 2020. The provisional application is incorporated by reference as if fully provided herein.

### FIELD

This disclosure relates to the field of service provider matching services, and in particular, to matching service providers and customers with each other in a service marketplace.

### BACKGROUND

Customers sometimes find themselves in a position of having an immediate need of professional services, such as when a water heater suddenly begins leaking water in their basement. These types of events are often unexpected and random in nature. Typically, the response to such an event is for the homeowner to attempt to identify and schedule a repair or replacement activity for the water heater with a service provider, such as a plumber. While the homeowner may find a wide variety of choices for service provider through various online and print advertisements, one major unknown for the homeowner is whether any particular service provider has the ability, time, or inclination to perform the service for the homeowner in a timely manner.

The result is that the homeowner is often tasked with contacting multiple potential service providers and engaging them in an ongoing discussion regarding costs for the work to be performed, scheduling availability for performing the work, determining whether a service provider operates in the geographical area of the homeowner, etc. Thus, the homeowner may expend significant time and effort to find a service provider that can meet their service needs.

In addition, service providers often spend considerable time and effort to find potential customers, including replying to various customer requests for information, providing information to potential customers regarding costs, service areas, and the services provided by the service provider, without any particular guarantee that the effort will actually result in a new customer for the service provider. Thus, the service provider may expend significant time and effort to obtain new customers.

Based on the forgoing discussion, it is apparent that there are improvements to be made regarding matching customers with service needs with service providers than can provide the requested services to the customer.

### SUMMARY

Embodiments described herein provide a platform for service provider engagement and management of service requests. A consumer may desire immediate assistance for repair or maintenance service but there may be many service professionals in the area. The platform described herein implements discriminatory parameters to narrow the list of potential service providers that are most likely to match a customer's request. Additionally, the platform can directly connect potential service providers with the consumer without releasing the privacy details of the consumer unless an appointment is ultimately booked.

One embodiment is a system that includes a server with an interface and a controller. The interface configured to receive, from provider devices, service profiles of maintenance providers, and to receive from a customer device, a service request. The controller is configured to: determine, from among the maintenance providers, candidate maintenance providers capable of fulfilling the service request based on the service profiles; generate a provider page to display data of the service request for a provider device of each of the candidate maintenance providers, and to receive a reply communication to the service request by one or more replying maintenance providers among the candidate maintenance providers; generate a customer page to display, on the customer device, a list of the one or more replying maintenance providers, each entry of the list including a name, the reply communication, and at least one performance metric of each of the one or more replying maintenance providers; generate a communication page to exchange one or more messages between the customer device and at least one replying maintenance provider; receive a selection by the customer device indicating, from among the list of the one or more replying maintenance providers, a selected maintenance provider for performing the service request; generate a booking request for the selected maintenance provider; and in response to receiving acceptance of the booking request by the selected maintenance provider, provide customer contact information to the selected maintenance provider to facilitate performance of the service request.

In further embodiments, the controller is configured to determine the candidate maintenance providers based on one or more performance metrics of each maintenance provider; and to delay a time of displaying the data of the service request for one or more of the candidate maintenance providers based on the one or more performance metrics of each of the one or more of the candidate maintenance providers. In other embodiments, the controller is configured to modify the one or more performance metrics of the maintenance provider based on user-configured parameters, wherein the user-configured parameters include one or more of customer rating feedback supplied in response to completing service requests, a number of technicians indicated in the service profile, and a time availability indicated in the service profile. In another embodiment, the controller is configured to modify the one or more performance metrics of the maintenance provider based on automatically tracked parameters, wherein the automatically tracked parameters include one or more of a length of time the maintenance provider has been providing services, a credit history, an average time to reply to service requests, an average time of arrival to confirmed booking requests, and a historical comparison of estimated arrival times supplied in the reply communication and actual arrival times at confirmed booking requests.

In other further embodiments, the controller is configured to generate the customer page to display, on the customer device, an interactive window for generating the service request, wherein the interactive window populates selectable service options based on the service profiles of the maintenance providers, and wherein each service profile of a maintenance provider includes one or more of a type of service, a geographic area of service, available time of service, and a subcategory of service. In another embodiment, the controller is configured to, in response to receiving the acceptance of the booking request by the selected maintenance provider, automatically charge the selected maintenance a booking fee based on billing information in the service profile of the selected maintenance provider. In a further embodiment, the at least one performance metric of each of the one or more replying maintenance providers includes one or more of an estimated arrival window supplied in the reply communication, customer rating feedback supplied in response to completing service requests, and service charge information supplied in a corresponding service profile.

A further embodiment is a method. The method includes receiving, from provider devices, service profiles of maintenance providers, and receiving, from a customer device, a service request. The method also includes determining, from among the maintenance providers, candidate maintenance providers capable of fulfilling the service request based on the service profiles, and generating a provider page to display data of the service request for a provider device of each of the candidate maintenance providers, and to receive a reply communication to the service request by one or more replying maintenance providers among the candidate maintenance providers. The method further includes generating a customer page to display, on the customer device, a list of the one or more replying maintenance providers, each entry of the list including a name, the reply communication, and at least one performance metric of each of the one or more replying maintenance providers. The method also includes generating a communication page to exchange one or more messages between the customer device and at least one replying maintenance provider, and receiving a selection by the customer device indicating, from among the list of the one or more replying maintenance providers, a selected maintenance provider for performing the service request. The method further includes generating a booking request for the selected maintenance provider; and in response to receiving acceptance of the booking request by the selected maintenance provider, providing customer contact information to the selected maintenance provider to facilitate performance of the service request.

A further embodiment is a non-transitory computer readable medium embodying programmed instructions which, when executed by a processor, are operable for performing a method. The method may perform the steps similar to that described above. Other example embodiments (e.g., methods and computer-readable media relating to the foregoing embodiments) may be described below. The features, functions, and advantages that have been discussed can be achieved independently in various embodiments or may be combined in yet other embodiments, further details of which can be seen with reference to the following description and drawings.

### DESCRIPTION OF THE DRAWINGS

Some embodiments are now described, by way of example only, and with reference to the accompanying drawings. The same reference number represents the same element or the same type of element on all drawings.

FIG. 1 is a block diagram of a service engagement and management system in an illustrative embodiment.

FIG. 2 is a flow chart of a method operable by a customer client of the system of FIG. 1 in an illustrative embodiment.

FIG. 3 is a flow chart depicting additional details of the method of FIG. 2 in an illustrative embodiment.

FIGS. 4-25 depict various page views displayed to customers at the client device of the system of FIG. 1 in illustrative embodiments.

FIG. 26 is a flow chart of a method operable by a provider client of the system of FIG. 1 in an illustrative embodiment.

FIG. 27 is a flow chart depicting additional details of the method of FIG. 26 in an illustrative embodiment.

FIGS. 28-44 depict various page views displayed to service providers at the provider client of the system of FIG. 1 in illustrative embodiments.

FIG. 45 is a flow chart of a method operable by a server of the system of FIG. 1 in an illustrative embodiment.

### DETAILED DESCRIPTION

The figures and the following description illustrate specific exemplary embodiments. It will be appreciated that those skilled in the art will be able to devise various arrangements that, although not explicitly described or shown herein, embody the principles described herein and are included within the contemplated scope of the claims that follow this description. Furthermore, any examples described herein are intended to aid in understanding the principles of the disclosure are to be construed as being without limitation. As a result, this disclosure is not limited to the specific embodiments or examples described below, but by the claims and their equivalents.

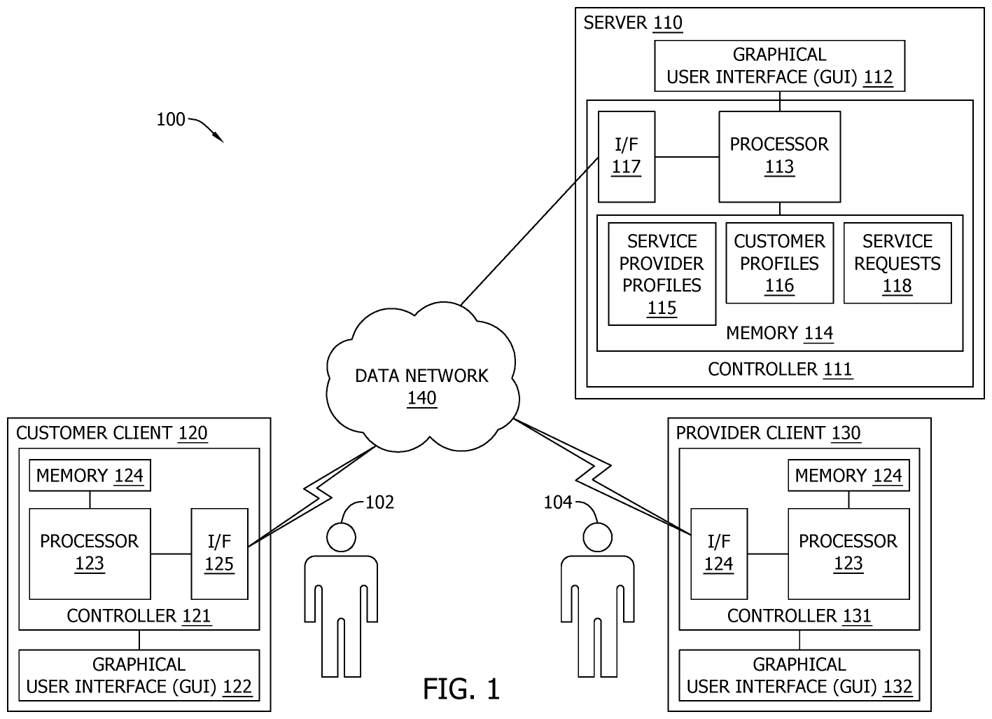

FIG. 1 is a block diagram of a service engagement and management system 100 in an illustrative embodiment. In this embodiment, system 100 performs various functions that allows customers 102 and service providers 104 to interact with each other in order to solve service-related problems that customers 102 may have, and to allow service providers 104 to quickly identify and obtain customers 102 to provide their services to. For example, customer 102 may be in need of locating the appropriately skilled service provider 104 in order to solve a problem with an air conditioning system in the home of customer 102. Generally, system 100 operates to allow customers 102 to locate service providers 104 that can solve their problems expediently. In particular, system 100 operates to quickly match customers 102 with service providers 104 based on among other criteria, the type of service requested by customers 102, the geographical location of customer 102, and the time frame that customer 102 is requesting for performing the services.

For example, if customer 102 has an immediate need of a plumber to replace a leaking water heater in a basement, then system 100 may allow customer 102 to locate service providers that, at a minimum, (1) have the skills to repair or replace the water heater, (2) operate in the geographical area of where the home is located, and (3) can begin the repair/replace process for the water heater within a time frame requested by customer 102. Thus, system 100 provides the technical benefit of reducing the time and effort for customers 102 to located service providers 104 that can meet their immediate service needs, and also provides the technical benefit of reducing the time and effort for service providers 104 to obtain customers 102 that have service needs.

In this embodiment, system 100 includes a server 110, that manages the interaction between customers 102 and service providers 104 using customer client 120 and provider client 130, respectively. In particular, server 110 communicates with customer client 120 and provider client 130 via a data network 140. Data network 140 may comprise, for example, a wireless network, a wired network, or a combination of wireless and wired networks. Some examples of wireless networks include Wi-Fi, cellular networks, etc. Some examples of a wired network include cable networks, optical fiber networks, telephone networks, etc. Data network 140 may include or provide access to, for example, the Internet.

Some examples of customer client 120 and/or provider client 130 include smart phones, tablets, computers, etc. For example, the functionality described herein for customer client 120 and/or provider client 130 may be implemented as an application executing on a smart phone used by customers 102 and/or service providers 104. In another example, the functionality described herein for customer client 120 and/or provider client 130 may be implemented on a personal computer through a web browser and/or an application executing on the personal computer.

In this embodiment, server 110 includes a controller 111 and a Graphical User Interface (GUI) 112, which implement the functionality described herein for server 110. Some examples of GUI 112, and any subsequent GUI described herein, include display devices, touch screens, keyboards, a mouse, etc.

While the specific hardware implementation of controller 111 is subject to design choices, one particular embodiment may include one or more processors 113 communicatively coupled with a memory 114. Processor 113, and any subsequent processor element described herein, includes any electronic circuits and/or optical circuits that are able to perform functions. For example, processor 113 may perform any functionality described herein for controller 111 and/or server 110. Processor 113, and any subsequent processor element described herein, may include one or more Central Processing Units (CPU), microprocessors, Digital Signal Processors (DSPs), Application-specific Integrated Circuits (ASICs), Programmable Logic Devices (PLDs), control circuitry, etc. Some examples of processors include INTEL® CORE™ processors, Advanced Reduced Instruction Set Computing (RISC) Machines (ARM®) processors, etc.

Memory 114, and any subsequent memory element described herein, includes any electronic circuits, and/or optical circuits, and/or magnetic circuits that are able to store data. For instance, memory 114 may store service provider profiles 115, which may include information about service providers 104 such as the types of services provided by service providers 104, the hours of operation of service providers 104, the geographical area of operation of service providers 104, etc. Memory 114 may store customer profiles 116, which may include information about customers 102 such as the contact information for customers 102. Memory 114 may also store service requests 118 generated by customers 102, which may include what services are being requested by customers 102, the address where the service will be performed, a time frame for when customer 102 would like service providers 104 to arrive at the service address, etc.

Memory 114, and any subsequent memory element described herein, may include one or more volatile or non-volatile Dynamic Random-Access Memory (DRAM) devices, FLASH devices, volatile or non-volatile Static RAM devices, magnetic disk drives, Solid State Disks (SSDs), etc. Some examples of non-volatile DRAM and SRAM include battery-backed DRAM and battery-backed SRAM.

Controller 111 in this embodiment includes an interface (I/F) 117, which allows server 110 to communicate with customer client 120 and/or provider client 130 via data network 140. I/F 117, and any subsequent interface device described herein, includes any component, system, or device that is able to provide network signaling and network frame processing capabilities between server 110, customer client 120, and provider client 130 via data network 140.

Further in this embodiment, customer client 120 includes a controller 121 and a GUI 122, which implement any functionality described herein for customer client 120. Controller 121 includes a processor 123, memory 124, and an I/F 125, which allows customer client 120 to communicate with server 110 and/or provider client 130 via data network 140. Generally, customer client 120 is used by customers 102 to obtain services from service providers 104, interacting with service providers 104 and/or server 110 via GUI 122.

Further in this embodiment, provider client 130 includes a controller 131 and a GUI 132, which implement any functionality described herein for provider client 130. Controller 121 includes a processor 123, memory 124, and an I/F 125, which allows customer client 120 to communicate with server 110 and/or provider client 130 via data network 140. Generally, provider client 130 is used by service providers 104 to interact with server 110 and customers 102 in order to provide services to customers 102.

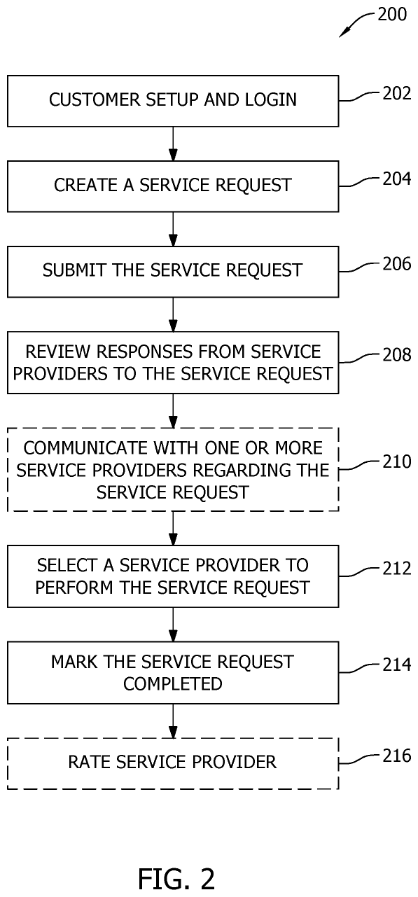

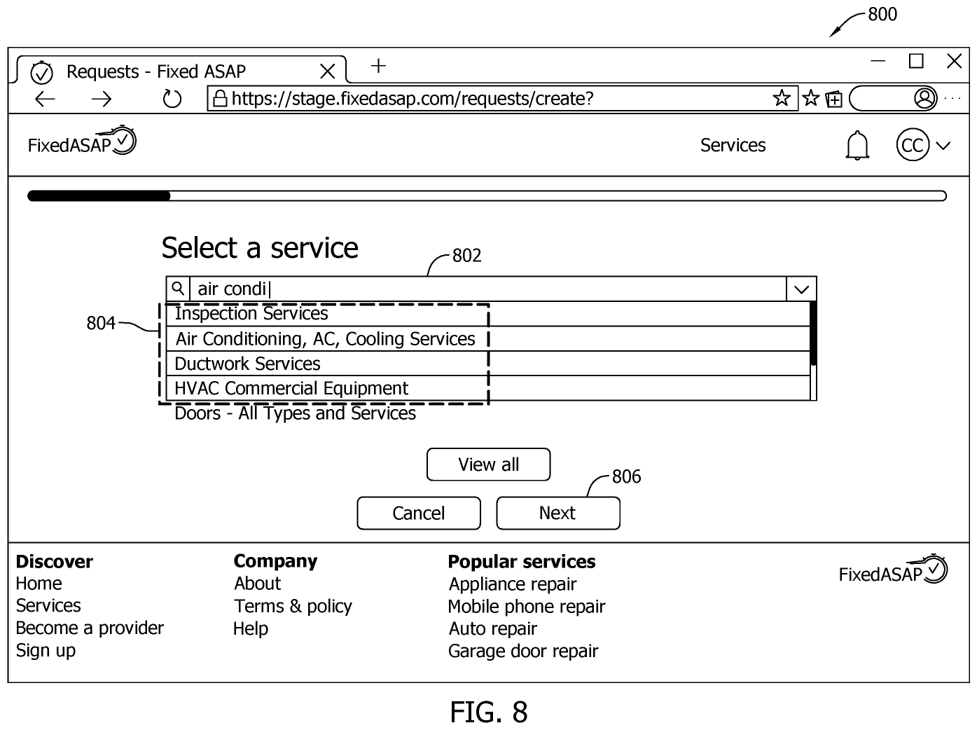

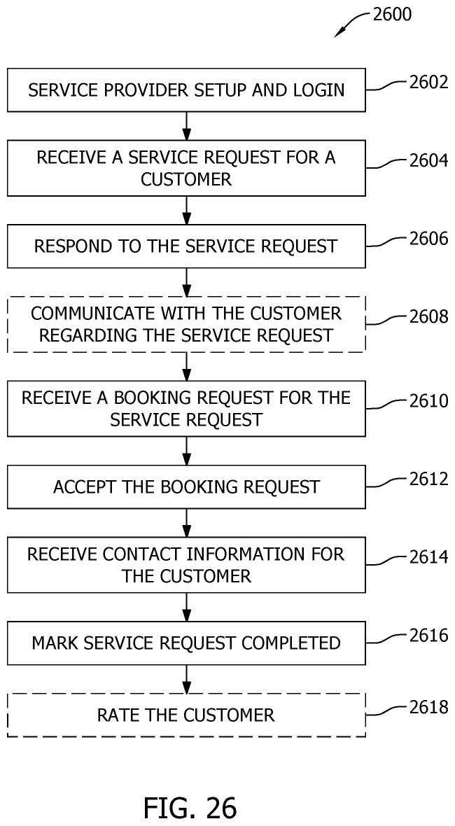

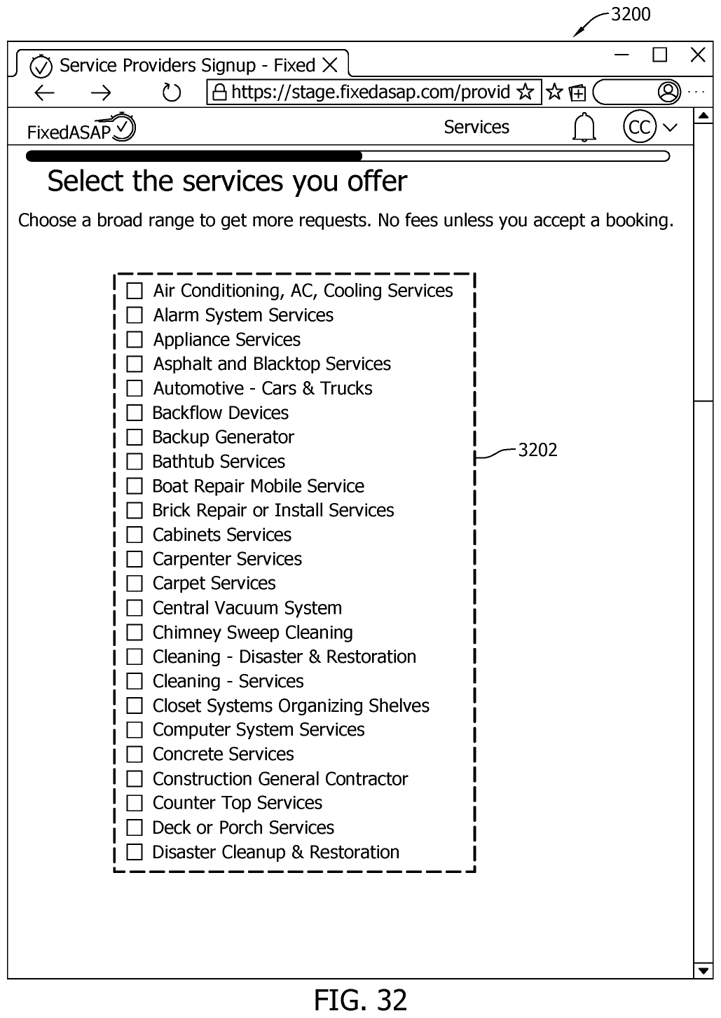

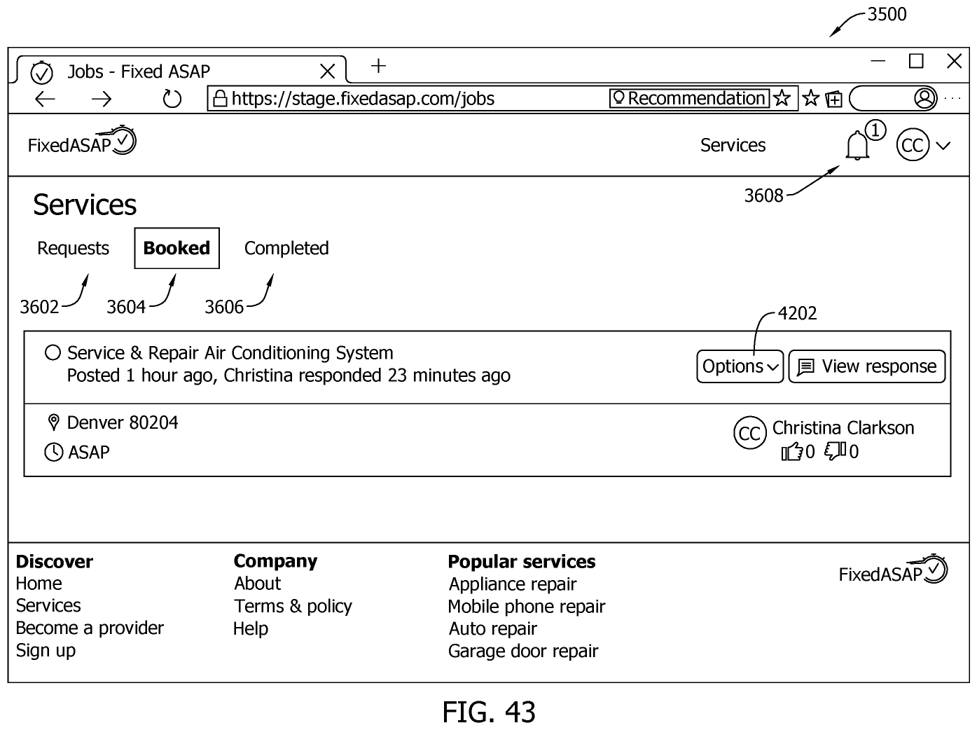

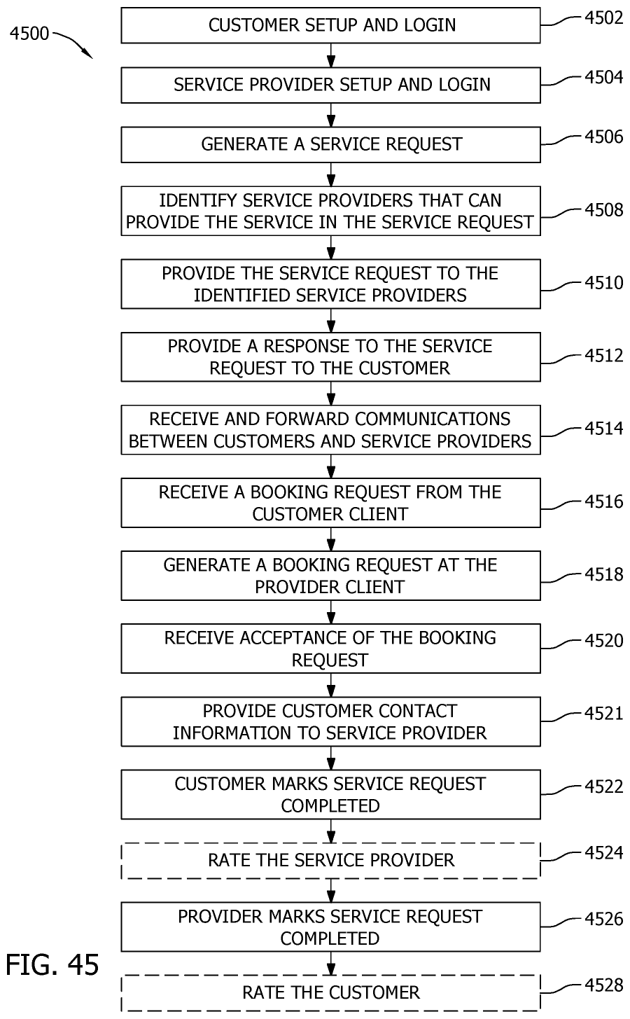

Consider that system 100 is in operation, customers 102 desire to utilize system 100 to locate and obtain services from service providers 104, and service providers 104 desire to engage with and provide services to customers 102. The functionality of system 100 will be described with respect to various workflows that will detail how different elements of system 100 interact. One workflow is a customer workflow which relates to how customers 102 interact with system 100 in order to obtain services from service providers 104. FIGS. 2-25 describe the customer workflow. Another workflow is a service provider workflow which relates to how service providers 104 interact with system 100 in order to match with and provide services to customers 102. FIGS. 26-44 relate to the service provider workflow. Another workflow is a server workflow which relates to how server 110 manages how customers 102 and service providers 104 interact with system 100 and each other. FIG. 45 relates to the server workflow.

### Customer Workflow

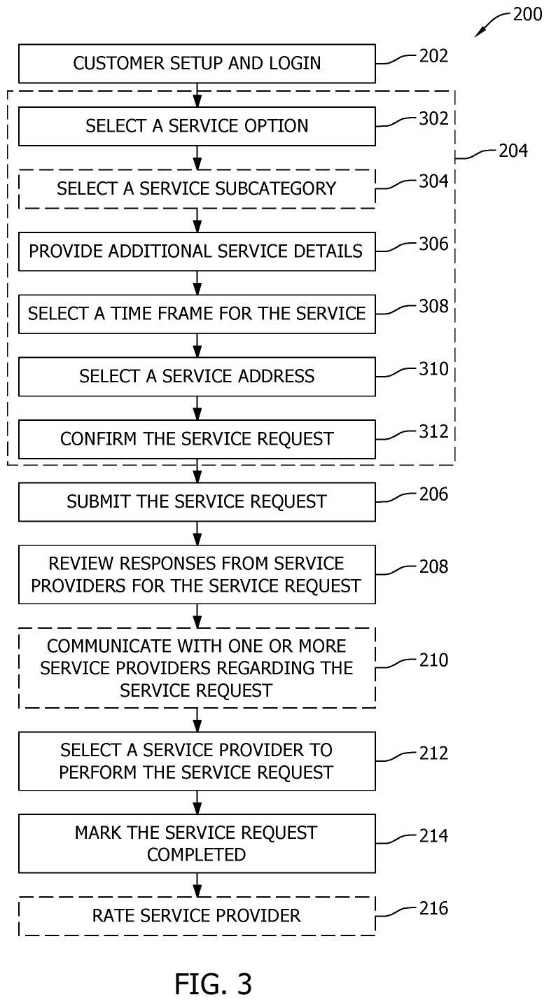

FIG. 2 is a flow chart of a method 200 operable by customer client 120 of system 100, in an illustrative embodiment, and FIG. 3 is a flow chart depicting additional details of method 200 in an illustrative embodiment. The steps of the flow charts described herein may include other steps, not shown. Also, the steps of the flow charts described herein may be performed in an alternate order.

One aspect of system 100 is providing the ability for customers 102 to request services from service providers 104, and to select one or more service providers 104 to perform the requested services. To do so, customer 102 may first set up and log into an account with system 100, if one does not already exist (see step 202 of FIG. 2). To do so, customer 102 may utilize customer client 120 to interact with server 110. For example, if customer client 120 is a smart phone, then customer client 120 may execute an application and/or display a web page (e.g., via GUI 122) in order to allow customer 102 to access system 100.

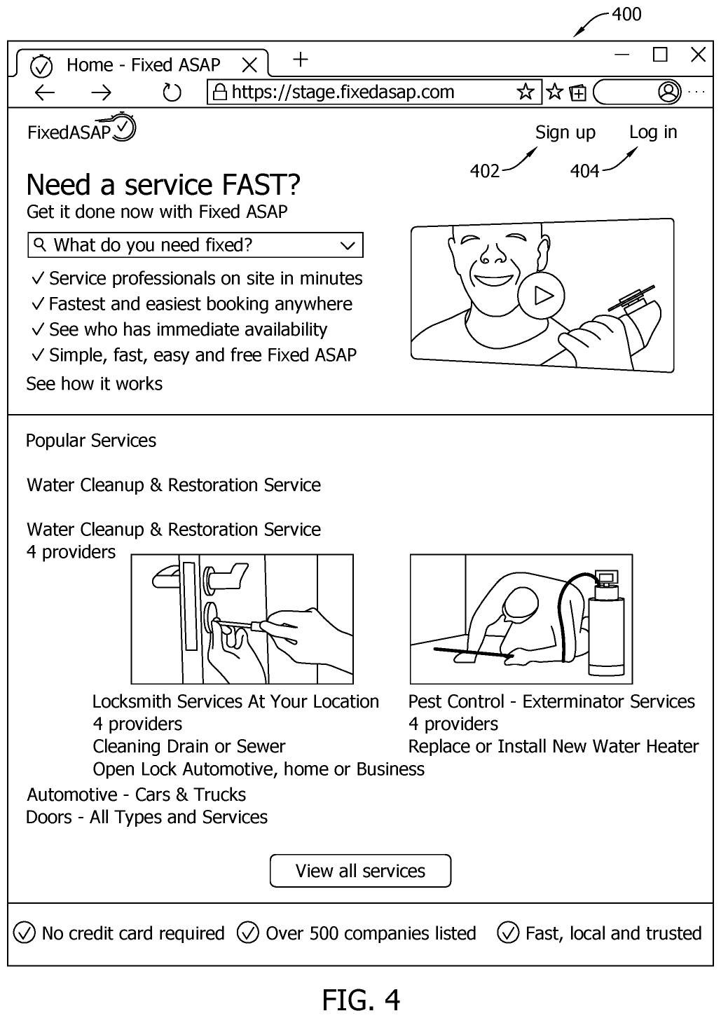

FIGS. 4-25 depict various page views displayed by server 110 to customer 102 via customer client 120 in illustrative embodiments. The layout and components of the page views depicted in FIGS. 4-25 are simply shown for the purpose of discussion, and the page views may have different layouts and components in other embodiments.

In this embodiment, a landing page 400 (see FIG. 4) is displayed in a web browser as a web page by GUI 122. Landing page 400 in this embodiment includes an option for signing up for access to system 100, via a sign-up option 402, and an option for logging in for access to system 100 if customer 102 and/or service provider 104 have previously created an account with system 100, via a log in option 404.

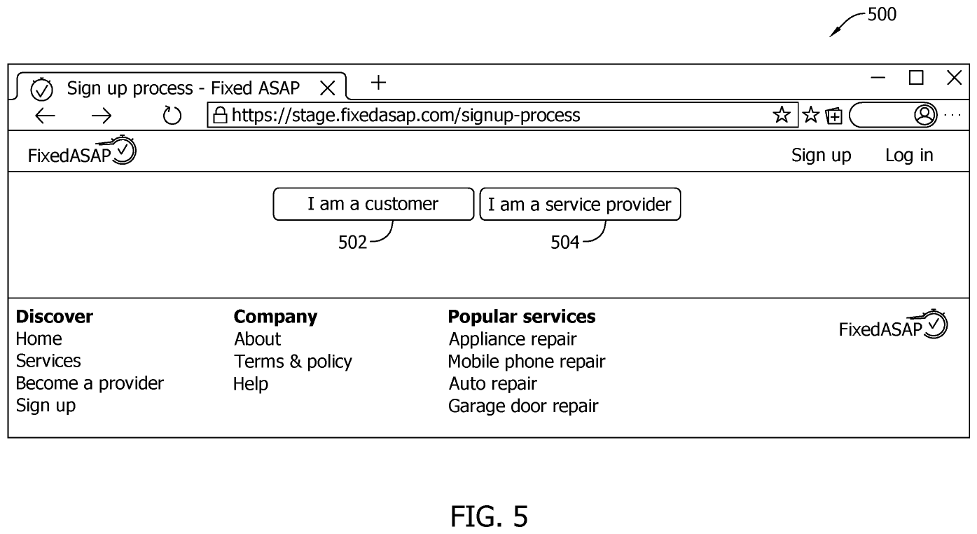

If customer 102 has not previously registered with system 100, customer chooses sign-up option 402, which may bring up web page 500 illustrated in FIG. 5. From web page 500, customer 102 is provided the option of selecting a customer option 502 or a provider option 504 during the sign-up process. Generally, customer option 502 is for new customers 102 and provider option 504 is for new service providers 104.

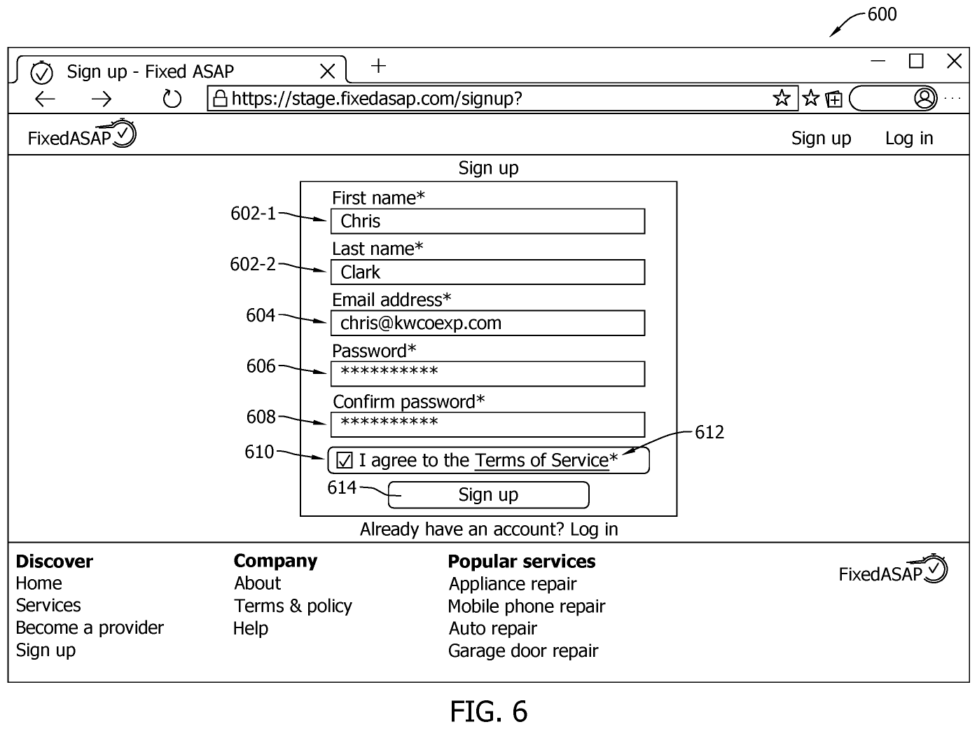

Since the example in this case is for a new customer 102, the appropriate choice is for customer 102 to choose customer option 502. Upon choosing customer option 502, web page 600 of FIG. 6 may be displayed to customer 102 in order to complete the sign-up process. Customer 102 may then enter various personal information using GUI 122 of customer client 120, including their name 602 (e.g., in a first name 602-1, last name 602-2 format in this example), an email address 604, and a password 606 (e.g., with a separate field 608 for confirming the password selected by customer 102). Customer 102 is then tasked to agree to the terms of service 610 prior to continuing, which may be displayed in a separate page (not shown) if customer selects a term of service link 612. The terms of service may include terms of use, a privacy policy, or any other type of agreement between system 100 and customer 102.

Once the information is entered, customer 102 selects a sign-up button 614 in order to complete the sign-up process, the result of which may store information about customer 102 in customer profile 116 at server 110.

Upon completing the sign-up process by customer 102, which may include a verification process by an administrator of system 100, a customer page 700 may be displayed by GUI 122 to customer 102, providing customer 102 with the option of creating a new service request 118 via a request new service button 702. Customers 102 may also review pending service requests 118 via a service request tab 704, review booked service requests 118 via a booked service request tab 706, and review completed service requests 118 via a completed service request tab 708, each of which will be discussed further below.

In response to customer 102 selecting request new service button 702, service page 800 may be displayed by GUI 122, which allows customer 102 to being creating a new service requests 118 utilizing a search window 802 to locate services.

As customer 102 begins typing information into search window 802, various service options 804 may be displayed by GUI 122 to customer 102. In this embodiment, service options 804 for creating a new service request 118 include “Inspection services”, “Air Conditioning, AC, Cooling Services”, “Ductwork Services”, and “HVAC Commercial Equipment”, although one of ordinary skill in the art will recognize that service options 804 may include any type of service that may be requested by customer 102. In one embodiment, service options 804 displayed to customer 102 are determined by server 110 based on service provider profiles 115, which include detailed information regarding the services provided by service providers 104 obtained during a service provider 104 sign-up process for system 100. This will be discussed later. In another embodiment, some service options 804 may not be displayed to customer 102 until a threshold number of service providers 104 are operating in the region associated with customer 102 and/or the service address for this service request 118. This prevents a low number of service providers 104 for a particular service from being overwhelmed by service requests 118 generated by customers 102.

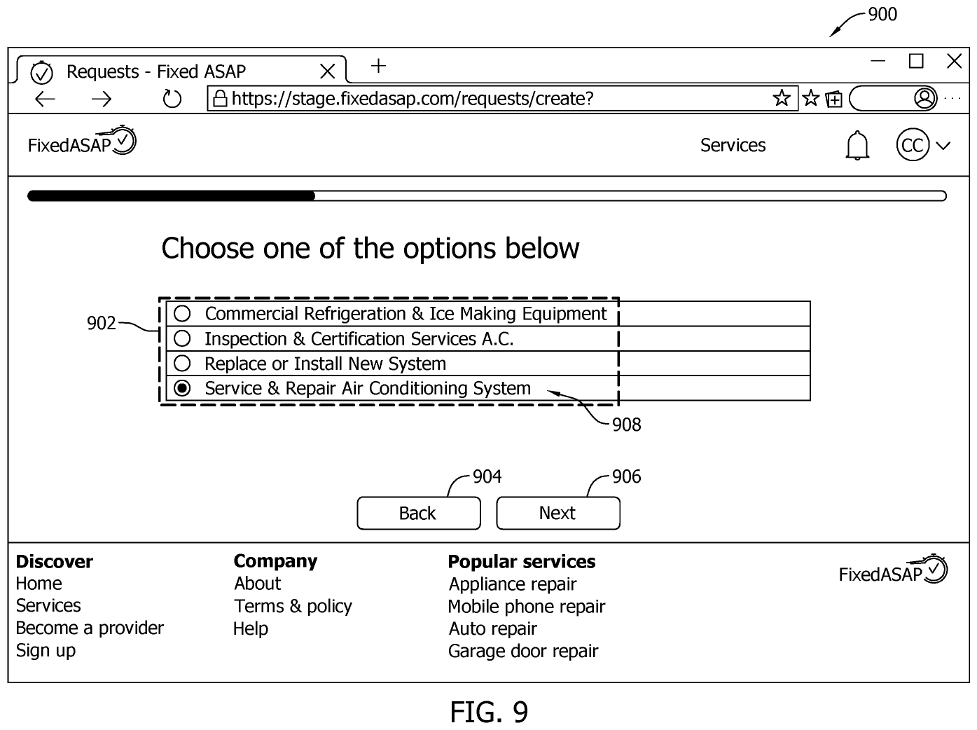

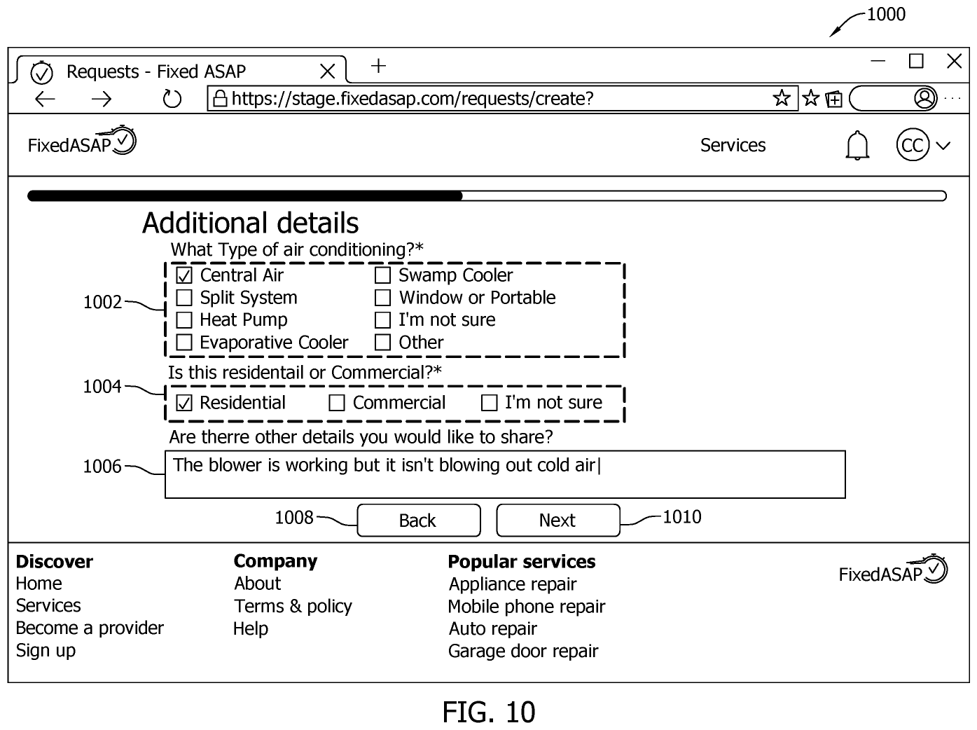

Once one of service options 804 are selected by customer 102 (see step 302 of FIG. 3; e.g., “Air Conditioning, AC, Cooling Services” is a service 908 selected by customer in this example), customer 102 may select a next button 806, which may then display an option page 900 (see FIG. 9) related the choice made by customer 102 on page 800 (see step 304 of FIG. 3). In some cases, service 908 selected by customer 102 may include various secondary options 902. In this example, secondary options 902 include “Commercial Refrigeration & Ice Making Equipment”, “Inspection & Certification Services A.C.”, “Replace or Install New System”, and “Service & Repair Air Conditioning System”, although one of ordinary skill in the art will recognize that secondary options 902 may include any type of subcategory that generally depend on the type of service being requested by customer 102. Once customer 102 selects one of secondary options 902 (e.g., FIG. 9 depicts that customer 102 has selected service 908 “Service & Repair Air Conditioning System” in this example), customer 102 may then select a back button 904 to return to page 800, or a next button 906, which may display a details page 1000 (see FIG. 10), if additional service details for the selected service are requested from customer 102 in order to generate service request 118 (see step 306 of FIG. 3).

In this example, customer 102 is asked to provide additional details regarding the type of air conditioner, which includes AC option types 1002 in this embodiment such as “Central Air”, “Split System”, “Heat Pump”, “Evaporative Cooler”, “Swamp Cooler”, “Window or Portable”, “I'm not sure”, and “Other”, with customer 102 selecting “Central Air” in this example.

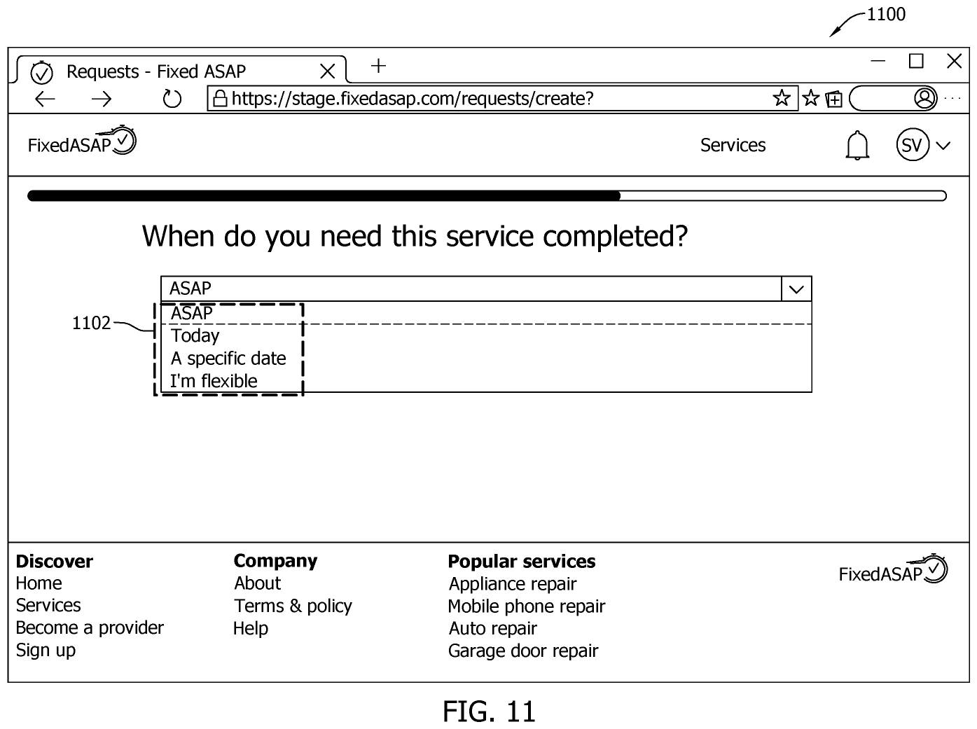

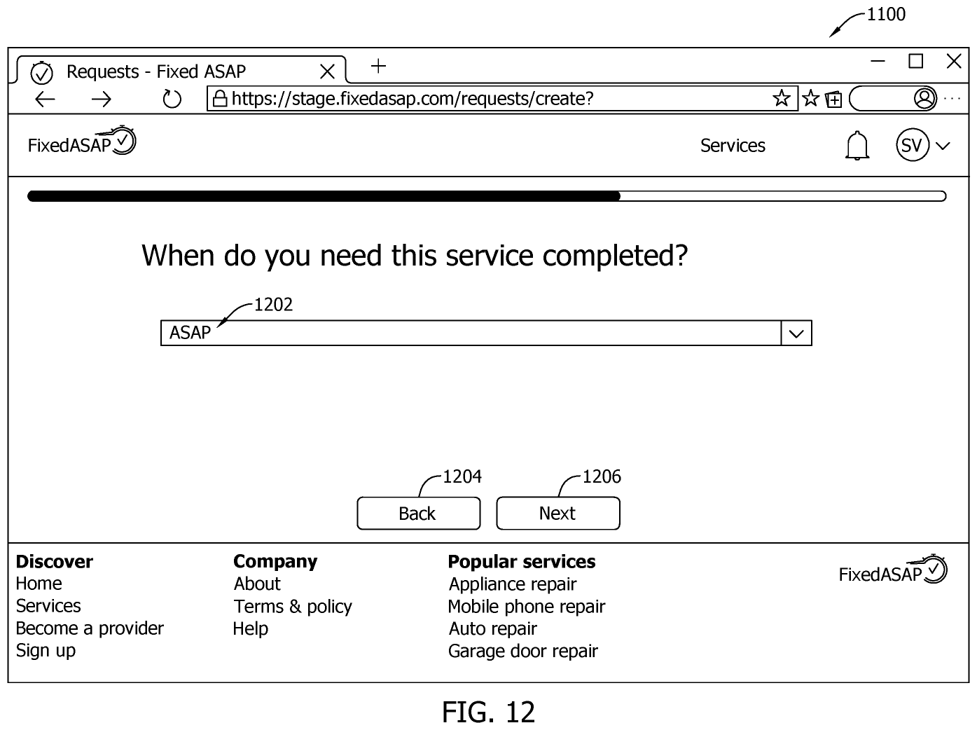

Customer 102 may then be asked to provide additional details regarding whether the AC system is residential or commercial, with options 1004 in this category including “Residential”, “Commercial”, and “I'm not sure”. In this example, customer 102 selects “Residential”, and may optionally enter information into a text box 1006. The information entered into text box 1006 may be included in service request 118 in order to provide service providers 104 with information regarding what problem customer 102 is having with their AC system. Customer 102 may then either select a back button 1008 to return to page 900, or a next button 1010 to continue on with creating service request 118. Upon selecting next button 1010, page 1100 of FIG. 11 may be displayed to customer 102 to allow customer 102 to select a time frame options 1102 when customer 102 would like the selected service to be completed (see step 308 of FIG. 3). In this embodiment, time frame options 1102 include “ASAP” (As Soon As Possible), “Today”, “A specific Date”, and “I'm Flexible”. In this example, customer 102 selects time frame 1202 “ASAP” for service request 118, as depicted in FIG. 12.

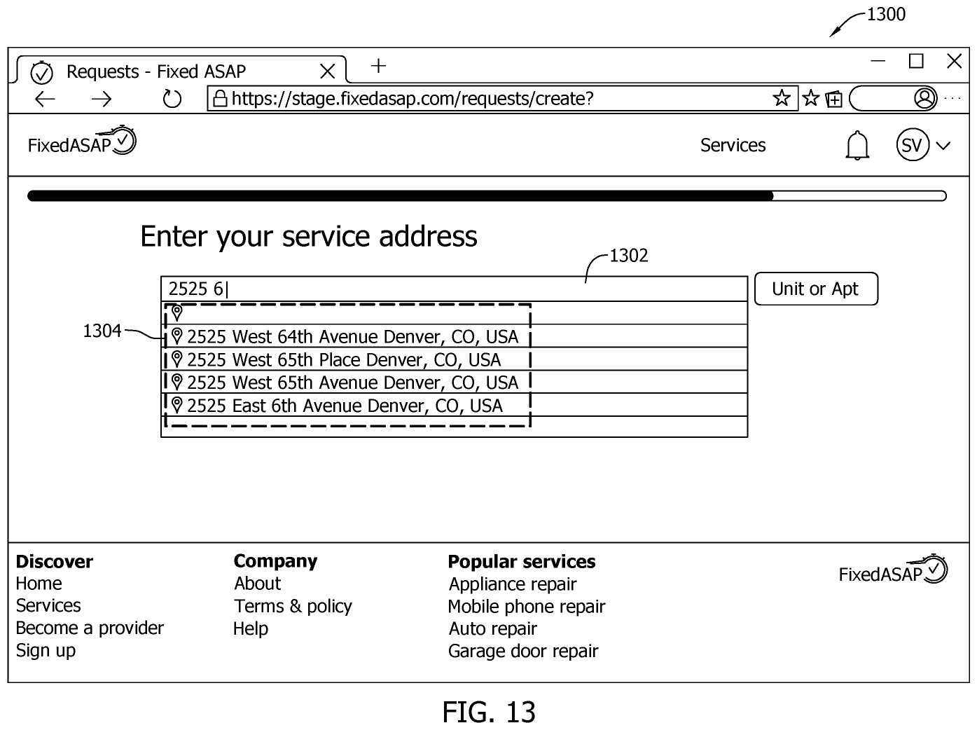

Once customer 102 has selected time frame 1202 as depicted in FIG. 12, customer may select a back button 1204 to return to details page 1000, or a next button 1206 to continue with creating service request 118 by entering a service address where service 908 is to be performed as shown in an address page 1300 illustrated in FIG. 13.

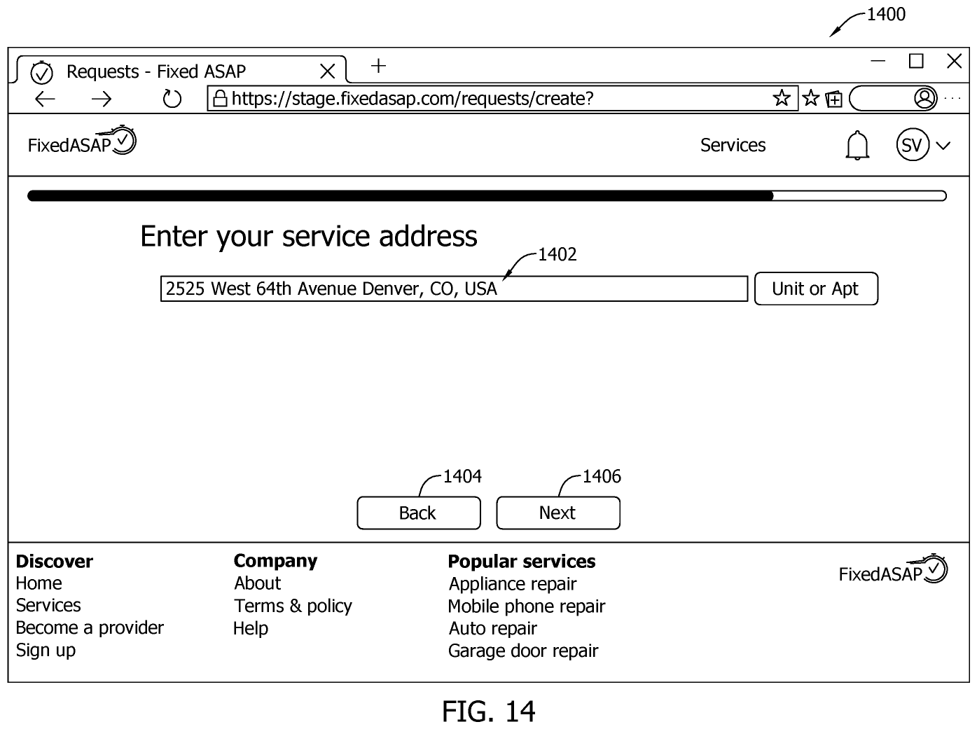

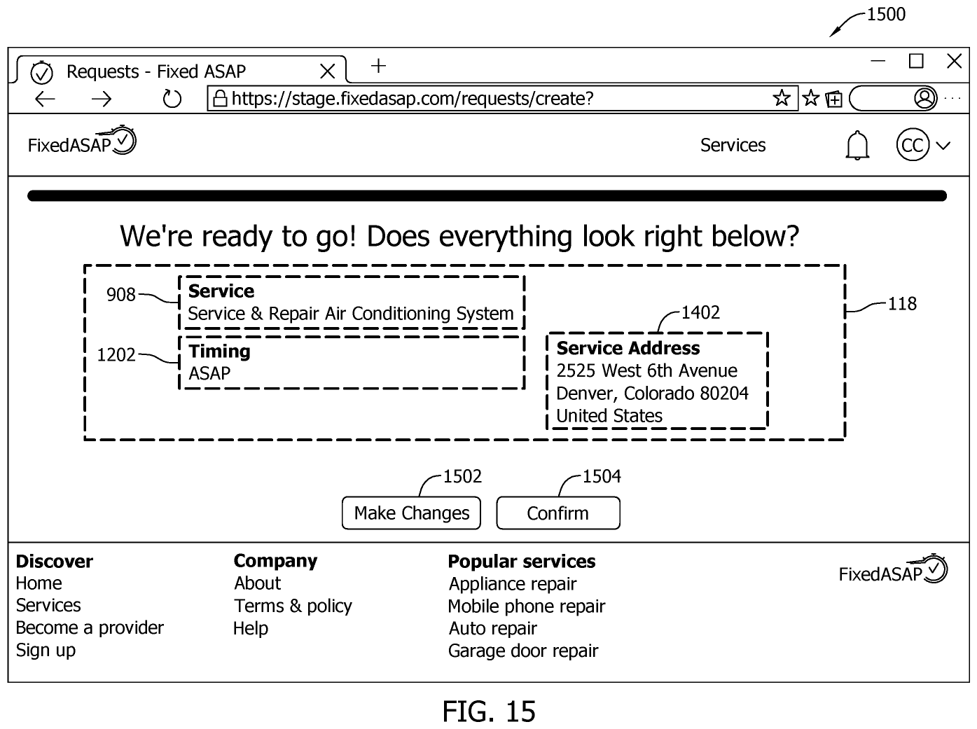

Address page 1300 allows customer 102 to enter the address where the service is to be performed (see step 310 of FIG. 3). For example, customer 102 may utilize a search bar 1302 to search and select a service address from options 1304 where customer 102 would like service providers 104 to perform the requested service, the result of which is displayed in FIG. 14. FIG. 14 indicates that customer 102 has specified a service address 1402 as “2525 West 6^{th} Avenue, Denver, Colo., USA”. Customer 102 may then select a back button 1404 to return to page 1100, or a next button 1406 to continue creating service request 118. Selecting next button 1406 by customer 102 may display a confirmation page 1500 as depicted in FIG. 15. Confirmation page 1500 allows customer 102 to review service request 118 prior to submission to server 110, which includes service 908 requested by customer 102, time frame 1202 selected by customer 102, and service address 1402 selected by customer 102 using the process previously described.

At this point, customer 102 may choose a make changes button 1502 if changes are desired or a confirm button 1504 if service request 118 is ready for submission to server 110 (see step 312 of FIG. 3).

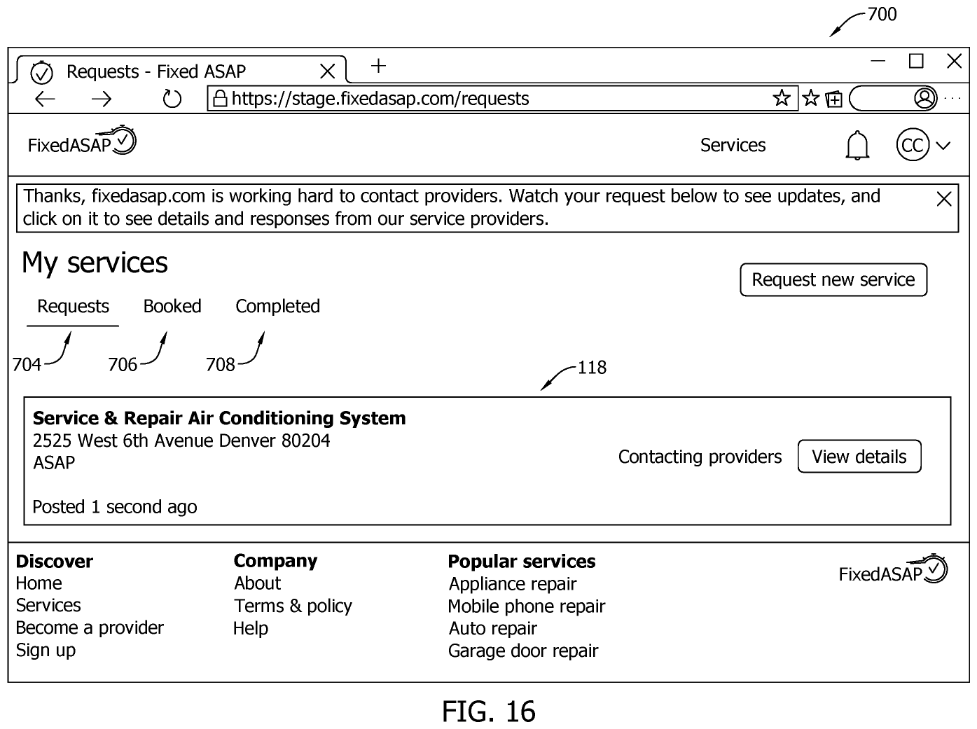

Selecting confirmation button 1502 may then submit service request 118 to server 110 for customer 102 (see step 206 of FIGS. 2-3). Returning to customer page 700 as depicted in FIG. 16 displays pending service request 118 under requests tab 704.

With service request 118 pending, server 110 contacts various service providers 104 that are able to provide service 908 to customer 102. This will be discussed later with regard to the server workflow and the service provider workflow.

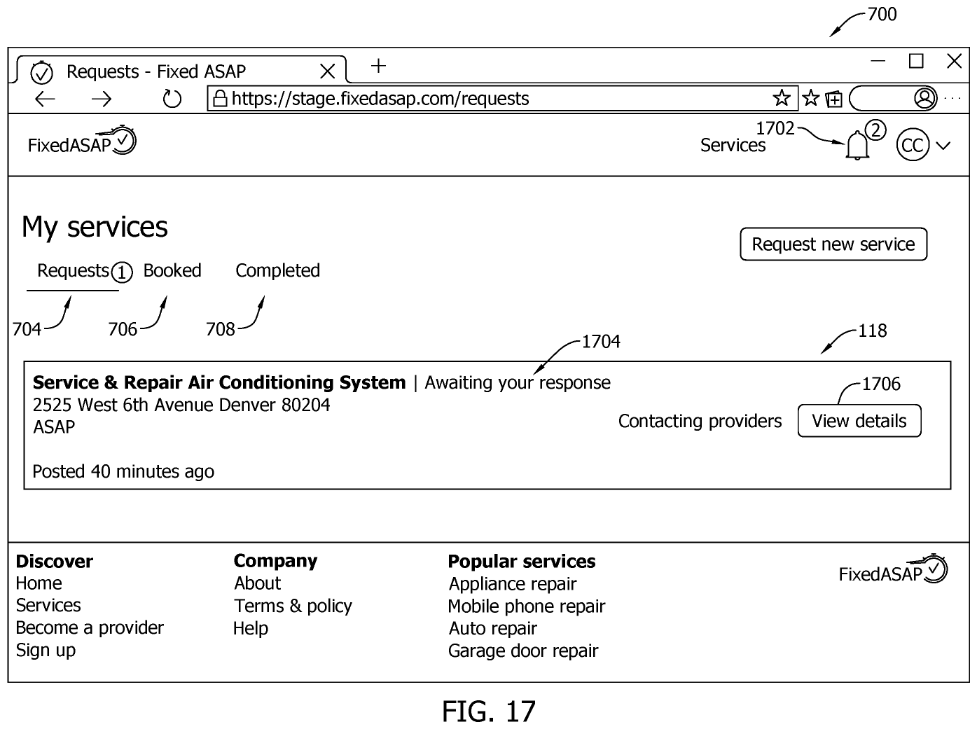

One or more of the contacted service providers 104 may then respond to service request 118, which may generate a notification 1702 at customer page 700 as depicted in FIG. 17. As illustrated in FIG. 17, a text alert 1704 may be generated for service request 118, indicating that at least one service provider 104 has responded to service request 118 that was submitted by customer 102. Customer 102 may, in some embodiments, receive Short Message Service (SMS) messages on their smart phone (e.g., at customer client 120) and/or emails to alert customer 102 that notification 1702 has been generated for service request 118.

In order to review the responses, customer 102 may select view details button 1706 on customer page 700 depicted in FIG. 17, which may then display a list of service providers 104 that have responded to service request 118 (see step 208 of FIGS. 2-3 and FIG. 18).

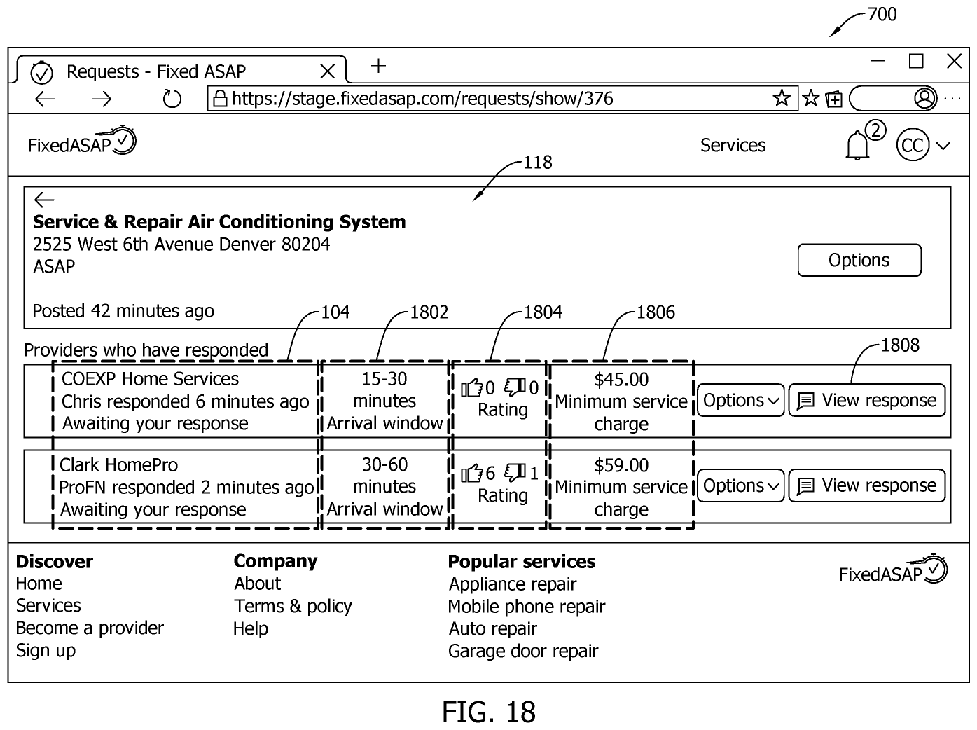

In FIG. 18, it is apparent that various types of information regarding the responses of service providers 104 may be presented to customer 102 on customer client 120. For example, service provider 104 “COEXP Home Services” indicates an arrival window 1802 at service address 1402 that is within fifteen to thirty minutes, that they currently have no customer ratings 1804, and that their minimum service charge 1806 is forty-five dollars. Minimum service charge 1806 may also indicate a minimum trip charge. In contrast, service provider 104 “Clark HomePro” indicates an arrive window 1802 of thirty to sixty minutes to service address 1402, that they have six positive customer ratings 1804, and that their minimum service charge 1806 and/or minimum trip charge is fifty-nine dollars.

In some embodiments, other types of information may be displayed regarding service request 118 on customer page 700, including how many service providers 104 have been contacted by system 100 for service request 118. In other embodiments, system 100 may limit a number of service providers 104 that can respond to service request 118, thereby preventing customer 102 from being overwhelmed by a large number of responses to service request 118 by service providers 104. For example, customer 102 may be presented with an ordered and/or shortened list of the first five or so offers (e.g., among the replying, candidate service providers 104) having a highest score based on one or a combination of discriminatory parameters such as third-party rating, on-time performance, distance between technician's location (e.g., van location) and the service location, information derived from artificial intelligence, etc. In some embodiments, the customer 102 can dismiss an offer to view additional offers such as a service provider 104 with the next highest calculated rating for the service request 118.

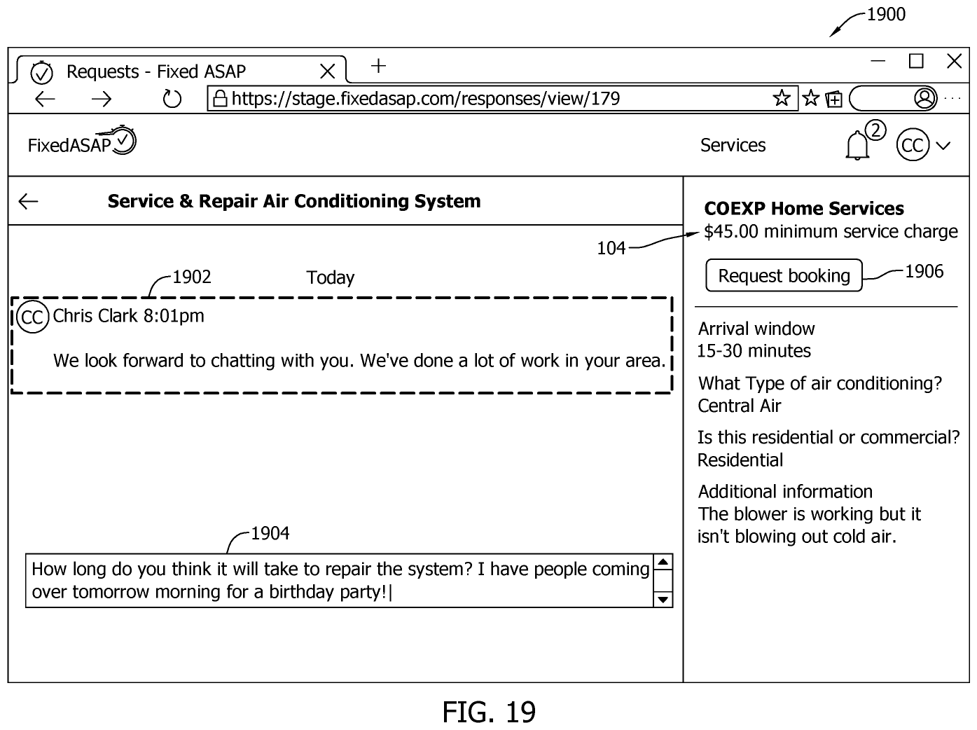

In this example, customer 102 had previously indicated an ASAP time frame for service request 118, and therefore customer 102 elects to view the response from “COEXP Home Services” by selecting a view responses button 1808 for this service provider 104, which may then display a communication page 1900 for “COEXP Home Services” as depicted in FIG. 19. In some embodiments, communication page 1900 may automatically open if a number of responses is less than a threshold value.

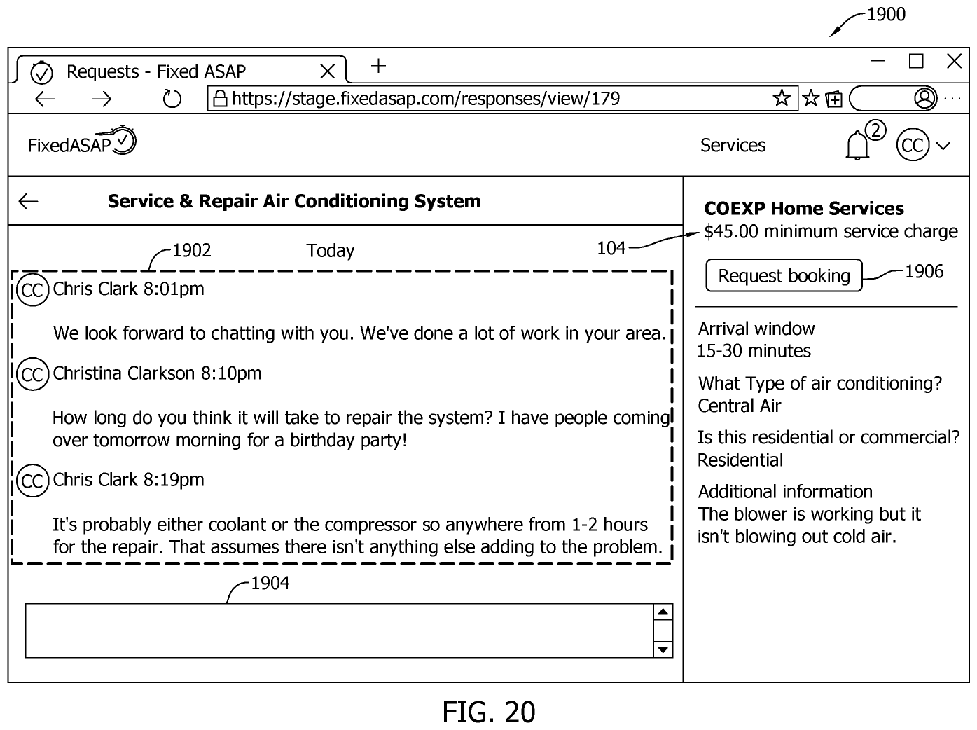

Communication page 1900 lists communications 1902 between service provider 104 “COEXP Home Services” and customer 102, and allows customer 102 to utilize customer client 120 to send messages to this responder via a text entry window 1904 (see step 210 of FIG. 3). Customer 102 and service provider 104 may communicate back and forth as desired until customer 102 is satisfied that service provider 104 “COEXP Home Services” is the right company for service request 118, at which point customer 102 may then select “COEXP Home Services” as service provider 104 for performing service request 118 using a request booking button 1906 on communication page 1900 of FIG. 20.

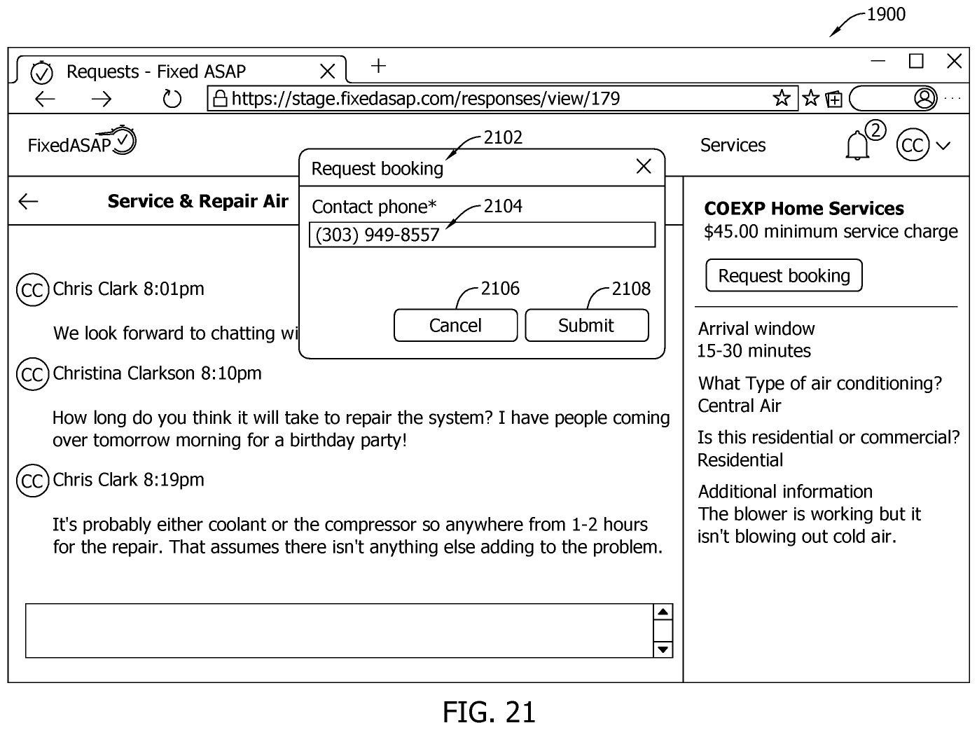

In response to customer 102 selecting “COEXP Home Services” as their service provider 104, communication page 1900 may display a booking window 2102 as depicted in FIG. 21 that allows customer 102 to enter a contact phone number 2104. This allows “COEXP Home Services” to contact customer 102 if additional information, such as determining the major cross streets at service address 1402 is desired by service provider 104. In response to customer 102 entering contact telephone number 2104 in booking window 2102, customer may then select a cancel button 2106 to cancel the request booking process, or a submit button 2108 on booking window 2102 in order to provide contact telephone number 2104 to service provider 104 and finalize the booking request (see step 212 of FIGS. 2-3). “COEXP Home Services”, in response to customer 102 selecting them for service request 118, may have the option to confirm this booking. This aspect will be discussed later with respect to the service provider workflow.

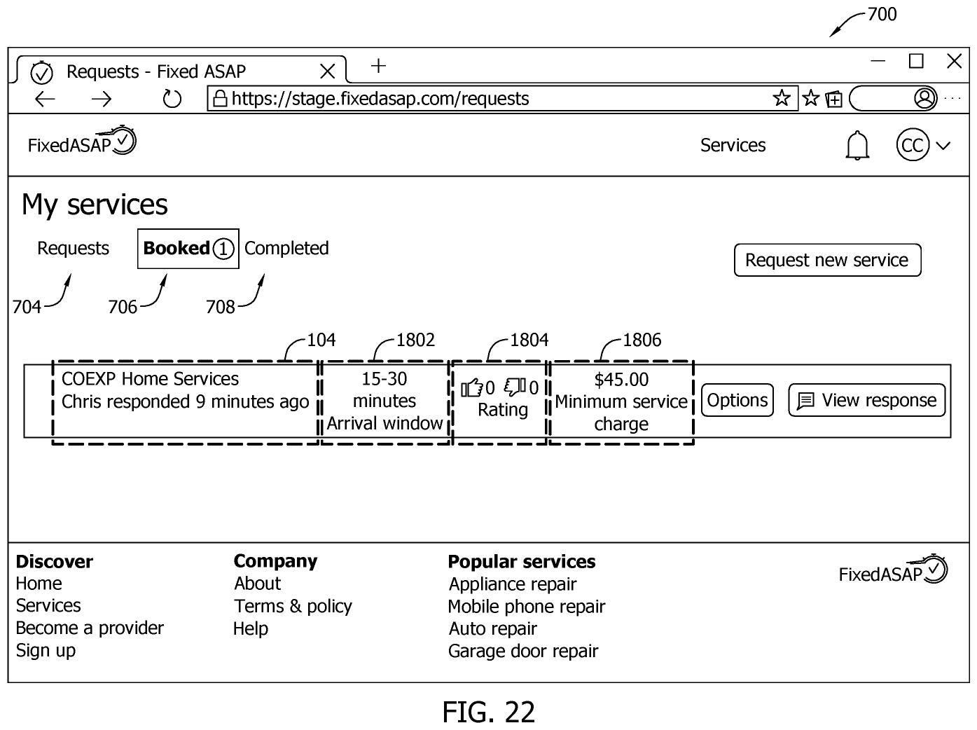

Once service request 118 is booked and accepted by service provider 104, customer 102 may be able to view this activity in booked services tab 706 as illustrated at customer page 700 of FIG. 22. Generally, once service request 118 is booked, customer 102 is unable to request a duplicate booking with a different service provider 104 unless service address 1402 is different and/or unless the requested service is different and/or in a different subcategory. This prevents customer 102 from booking the same service request 118 with multiple service providers 104. Customer 102 may also be prevented from generating a new duplicate service request 118 until the prior service request 118 is marked as completed.

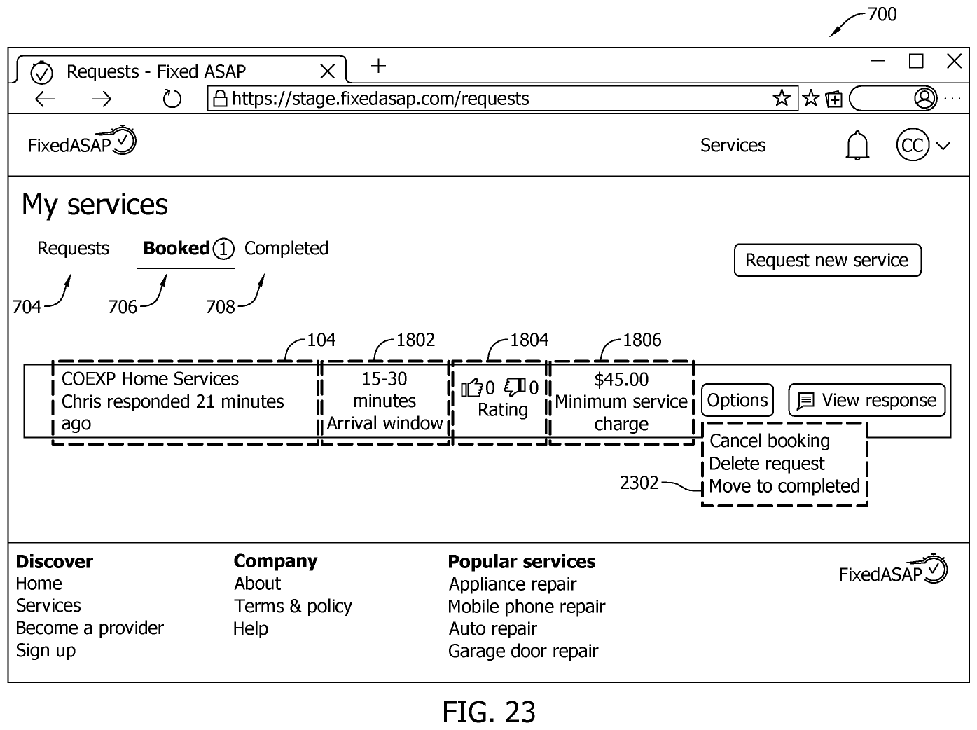

With service request 118 booked, customer 102 may have a number of options 2302 for this booking, including “Cancel booking”, “Delete request”, and “Move to completed” as depicted in FIG. 23. “Cancel booking” will cancel the booking with service provider 104, and send a notification to service provider 104, allowing customer 102 to pursue booking service request 118 with another service provider 104. “Delete request” will both cancel the booking and remove service request 118 from server 110. “Move to completed” is used by customer 102 when work is complete for service request 118.

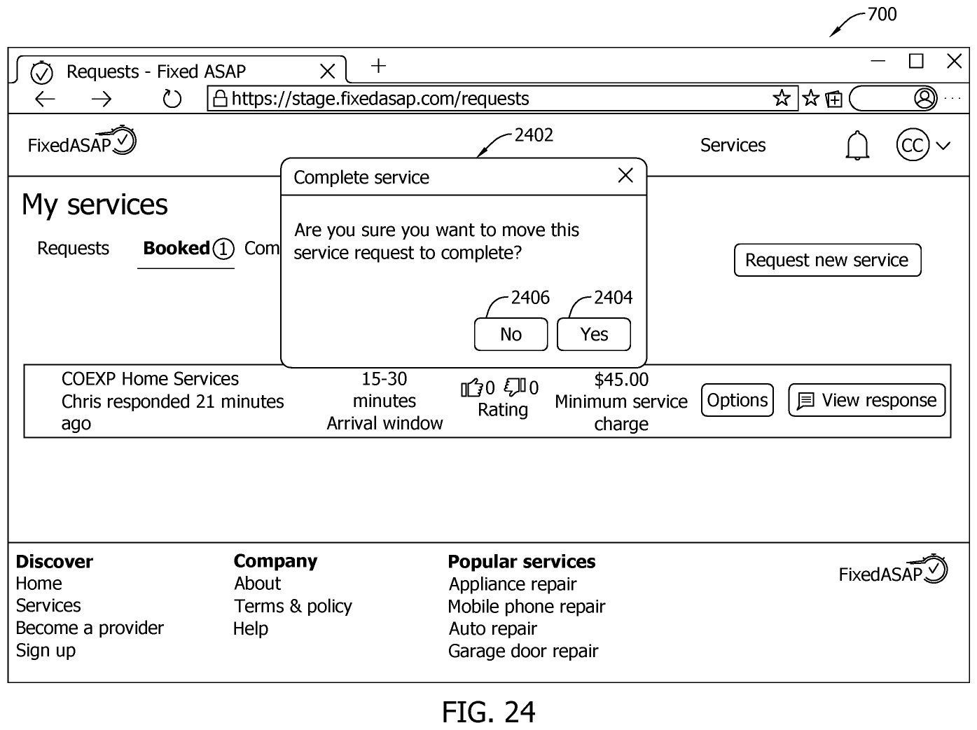

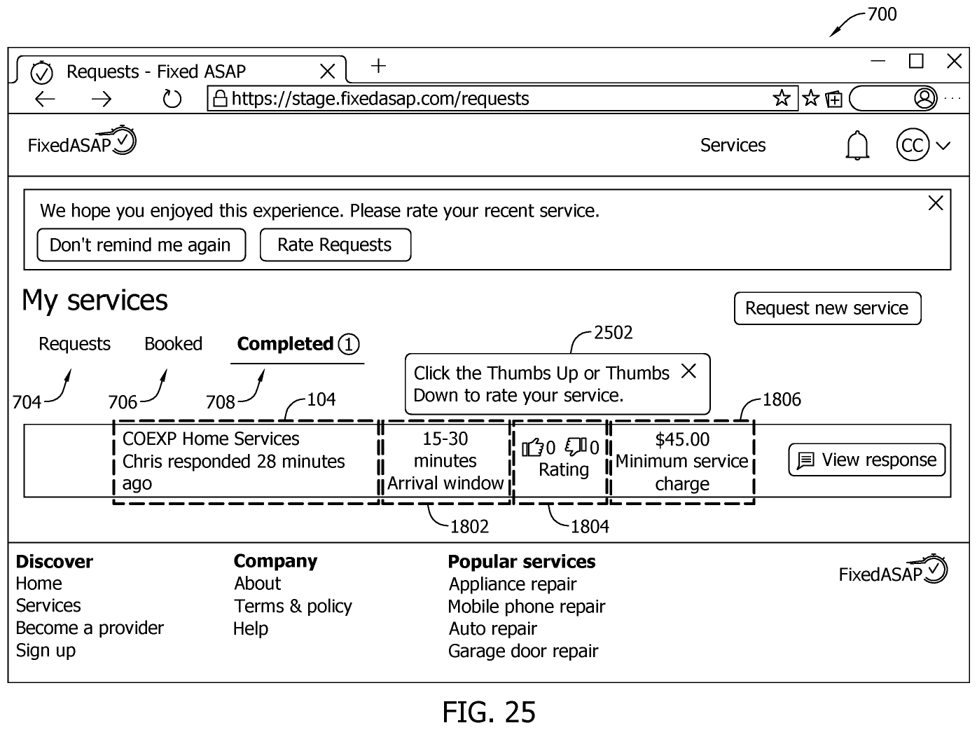

Once service provider 104 “COEXP Home Services” has completed service request 118, customer 102 may then indicate such by selecting “Move to completed” from options 2302. This activity may then bring up a complete service window 2402 on customer page 700, giving customer 102 the option to mark service request 118 completed by selecting button 2404 marked “Yes” as depicted in FIG. 24 (see step 214 of FIG. 3). Selecting button 2404 moves service request 118 to service completed tab 708 as depicted in FIG. 25, while selecting button 2406 marked “No” cancels this process. A rating notification window 2502 (see FIG. 24) may be generated for customer 102 in customer page 700 for completing service request 118, allowing customer 102 to assign rating 1804 to service provider 104 “COEXP Home Services”. Rating 1804 may then be presented to other customers 102 who may subsequently evaluate this particular service provider 104 before selecting them for their own service requests 118. In some embodiments, customer 102 may have an option to refer a friend to sign up with system 100 for some type of reward, including a fix or variable fee generated when the friend completes their own service request 118 with system 100.

### Service Provider Workflow

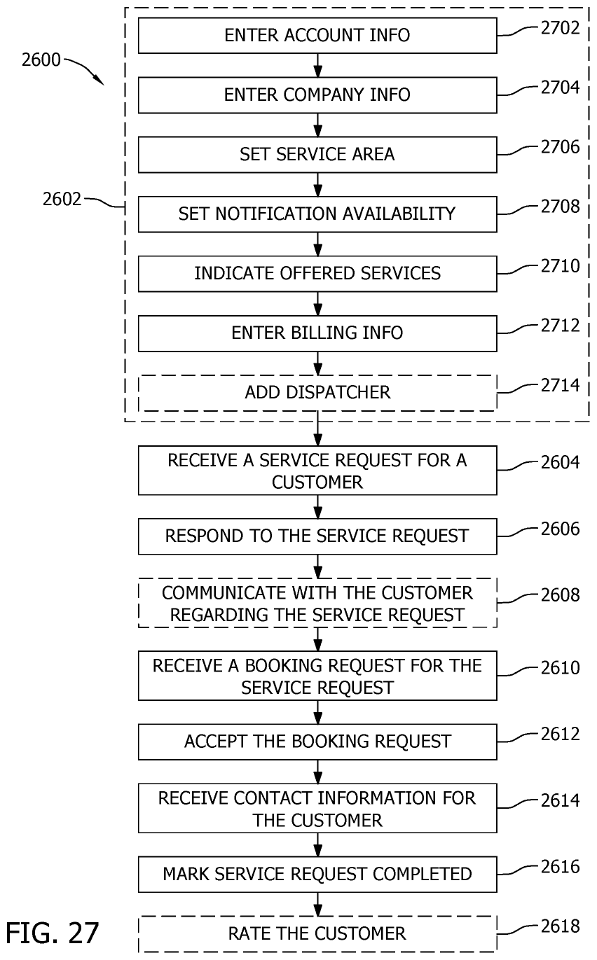

FIG. 26 is a flow chart of a method 2600 operable by provider client 130 of system 100 in an illustrative embodiment, and FIG. 27 is a flow chart depicting additional details of method 2600 in an illustrative embodiment.

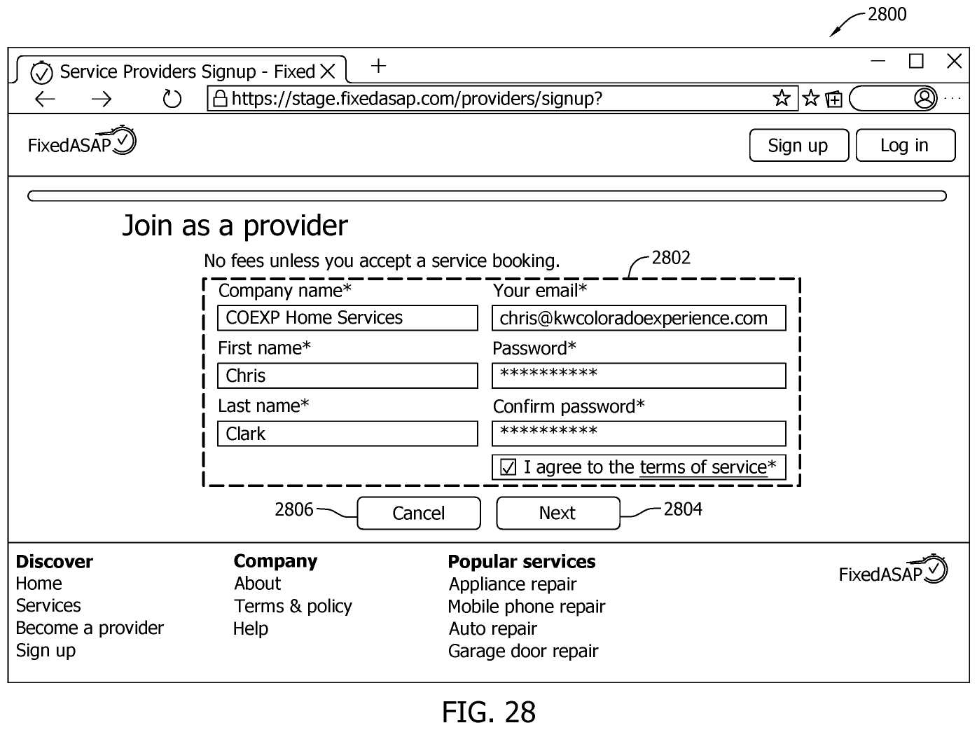

One aspect of system 100 is providing the ability for service providers 104 to provide services to customers 102, while limiting the number of customers 102 they may have to interact with that (1) are outside the service area of service provider 104, (2) are requesting services that are not offered by service provider 104, (3) may have a service time frame requirement that service provider 104 cannot currently accommodate, and (4) are generating service requests outside of normal business hours for service provider 104. To do so, service provider 104 may first set up and log into an account with system 100, if one does not already exist (see step 2602 of FIG. 26). FIGS. 28-44 depict various page views displayed by server 110 to service provider 104 via provider client 130 in illustrative embodiments. The layout and components of the page views depicted in FIGS. 28-44 are simply shown for the purpose of discussion, and the page views may have different layouts and components in other embodiments.

In this embodiment, landing page 400 (see FIG. 4) is displayed in a web browser as a web page by GUI 132 of provider client 130. Landing page 400 in this embodiment includes an option for signing up for access to system 100, via a sign-up option 402, and an option for logging in for access to system 100 if service provider 104 has previously created an account with system 100, via a log in option 404.

If service provider 104 has not previously registered with system 100, service provider 104 chooses sign-up option 402, which may bring up web page 500 illustrated in FIG. 5. From web page 500, service provider 104 is provided the option of selecting customer option 502 or provider option 504 during the sign-up process. Generally, customer option 502 is for new customers 102 and provider option 504 is for new providers 104.

Since the example in this case is for setting up a new service provider 104, the appropriate choice is for service provider 104 is to choose service provider option 504. Upon choosing service provider option 504, page 2800 of FIG. 28 may be displayed to service provider 104 on provider client 130 in order to complete the sign-up process. Service provider 104 may then enter information 2802 about the company and a contact person for the company using GUI 132 of provider client 130, including the company name, the user name, email address, password, etc. (see step 2702 of FIG. 27). Service provider 104 is then tasked to agree to the terms of service prior to continuing, which may be displayed in a separate page (not shown) if service provider 104 selects a term of service link. The terms of service may include terms of use, a privacy policy, or any other type of agreement between system 100 and service provider 104.

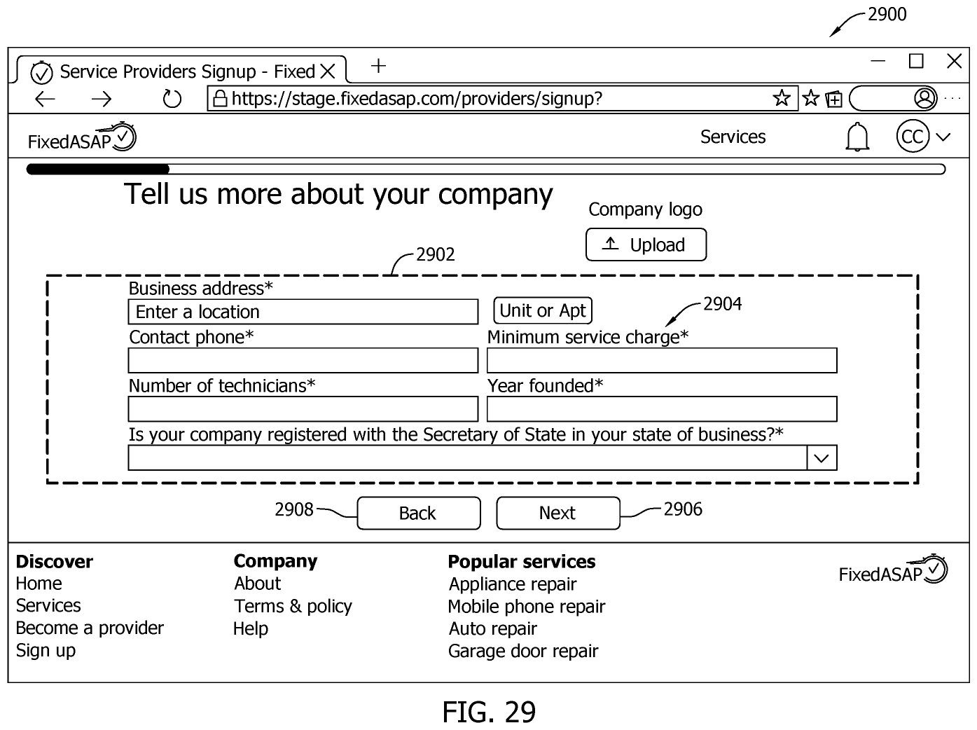

Once information 2802 is entered, service provider 104 selects a next button 2804 in order to continue the sign-up process, which may display page 2900 of FIG. 29, or may select a cancel button 2806 to cancel the sign-up process.

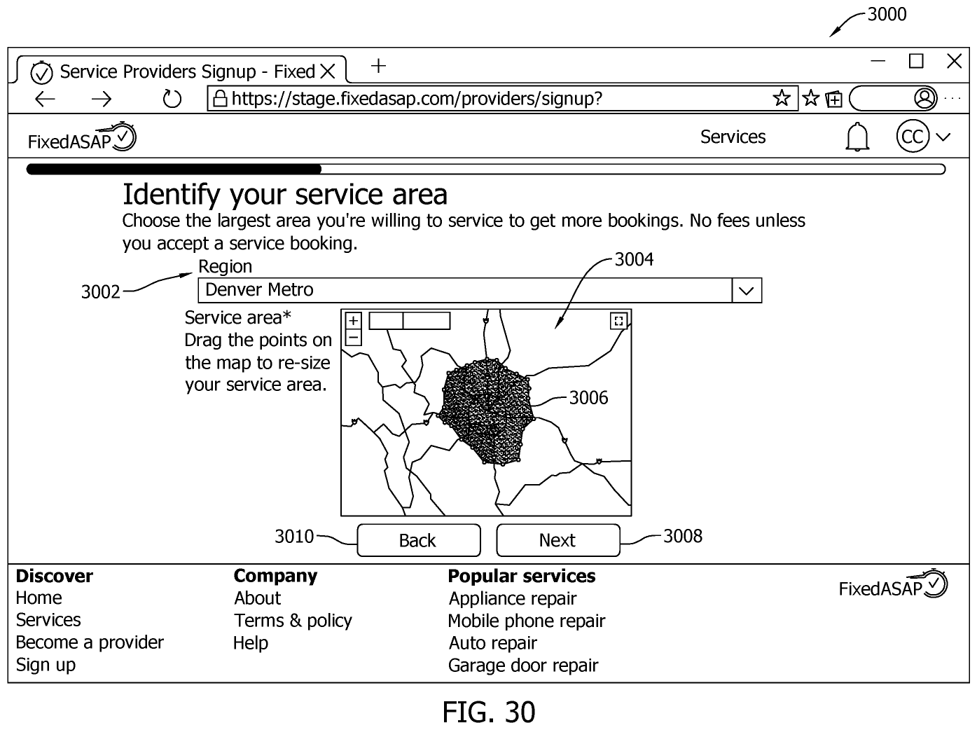

From page 2900, service provider 104 may enter additional information 2902 about the company, including the business address, a contact phone number, the number of technicians that work for the company, the minimum service charge 2904, the year founded, and information regarding whether the company is registered with the secretary of state in the state of business the company operates in (see step 2704 of FIG. 27). Service provider 104 may then select a next button 2906 to continue the sign-up process, or a back button 2908 to return to the prior page 2800. Selecting next button 2906 may continue to page 3000 of FIG. 30.

From page 3000, service provider may continue the sign-up process by selecting a service region 3002, which in the example illustrated for page 3000 is “Denver Metro” (see step 2706 of FIG. 27). The options available to service provider 104 may depend upon the areas of the country that system 100 is configured to operate in. In this case, provider client 130 may query server 110 to determine what options that region 3002 may display to service provider 104 when service provider 104 selects one of regions 3002 where service provider 104 operates its business. In response to selecting region 3002, a service area map 3004 is displayed on provider client 130, and service provider 104 is tasked with re-sizing a service area 3006 in order to indicate to system 100 what geographic area within region 3002 that service provider 104 would like to receive service requests for (see step 2706 of FIG. 27). For example, based on the extent of service area 3006 depicted on service area map 3004 in FIG. 30, service provider 104 is indicating to system 100 that system 100, for example, will provide service requests 118 from customers 102 that live in Denver to service provider 104 (if the type of service being requested by customer 102 is provided by service provider 104), and to not provide service requests from customers 102 that live in Fort Collins to service provider 104, even if the services requested from customer 102 match the services provided by service provider 104. This activity limits service requests from customers 102 that fall outside of the boundaries of service area 3006 set by service provider 104.

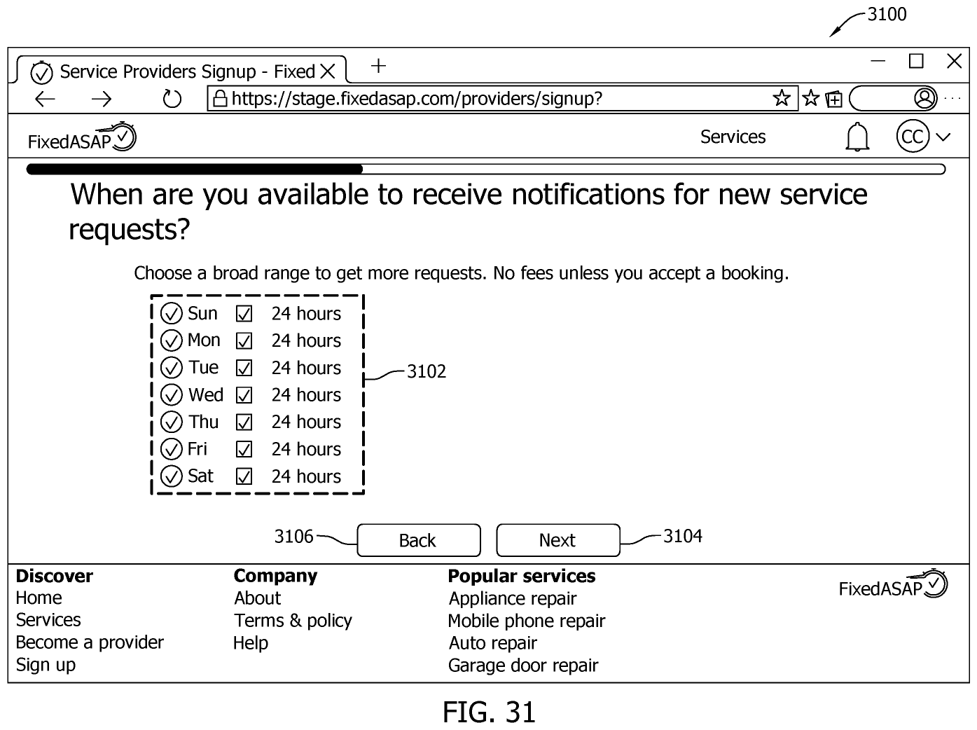

Once service provider 104 is satisfied of the boundaries of service area 3006 on service area map 3004, service provider 104 may select the next button 3008 to continue the sign-up process, or the back button 3010 to return to the prior page 2900. Selecting next button 3008 may display page 3100 of FIG. 31, which allows service provider 104 to indicate a notification time 3102 when service provider 104 would like to receive service notifications from system 100 (see step 2708 of FIG. 27). For example, service provider 104 may decide that provider client 130 will receive service notifications during typical business hours of Monday to Friday from 8 AM to 5 PM, and will not receive service notifications outside of these days and times. Once service provider 104 is satisfied with notification times 3102 selected on page 3100, service provider 104 may select a next button 3104 to continue the sign-up process, or a back button 3106 to return to page 3000 of FIG. 30.

At page 3200, service provider 104 selects various service options 3202 that service provider 104 is able to provide to customers 102 (see step 2710 of FIG. 27). For example, service provider 104 may select “Air Conditioning, AC, Cooling Services” from service options 3202, which informs server 110 how server 110 is to match service requests 118 from customers 102 to this service provider 104. Any number of service options 3202 may be selected by service provider 104. Generally, service options 3202 selected on page 3200 will instruct server 110 to potentially match customers 102 that are requesting these selected services via their service requests 118, while service options 3202 not selected on page 3200 will instruct server 110 to not match customers 102 that are requested the unselected services in their service requests 118. This activity minimizes the contact between customers 102 that are requesting services that service providers 104 do not provide.

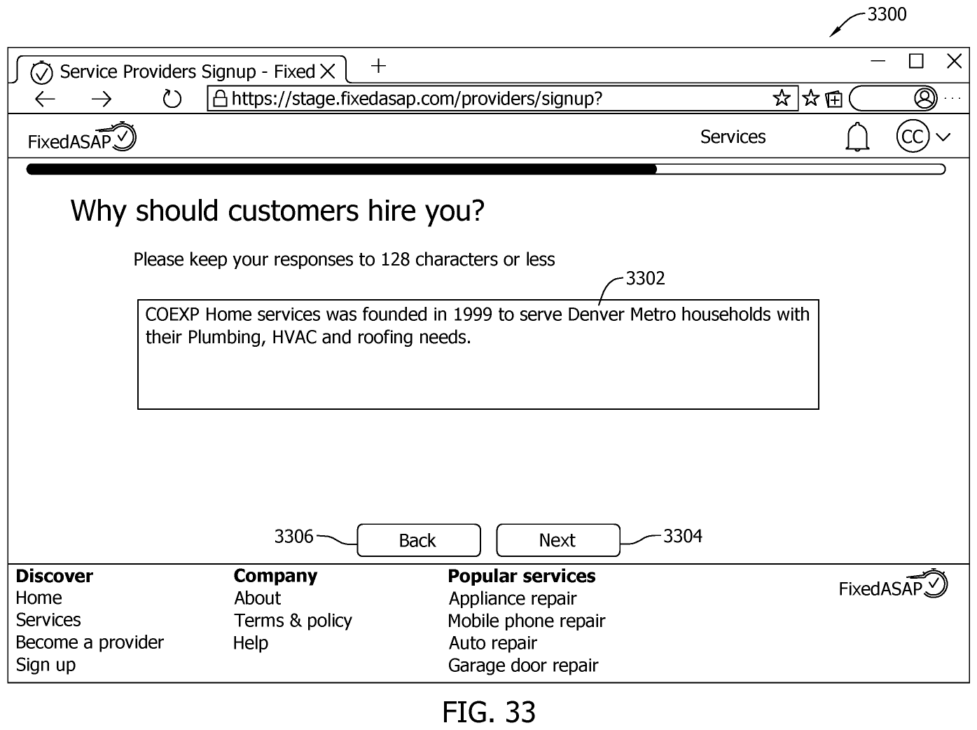

Once service provider 104 is satisfied with service options 3202 selected on page 3200, service provider 104 may continue the sign-up process by continuing to page 3300 of FIG. 33, using a next button (not shown), or may return to page 3100 using a back button (not shown). Page 3300 (see FIG. 33), allows service provider 104 to enter information in a text box 3302 about the company, which may be provided to customers 102 when customers 102 are reviewing information about service providers 104 that respond to their service requests 118. Service provider 104 may then select a next button 3304 to continue the sign-up process or a back button 3306 to return to page 3200.

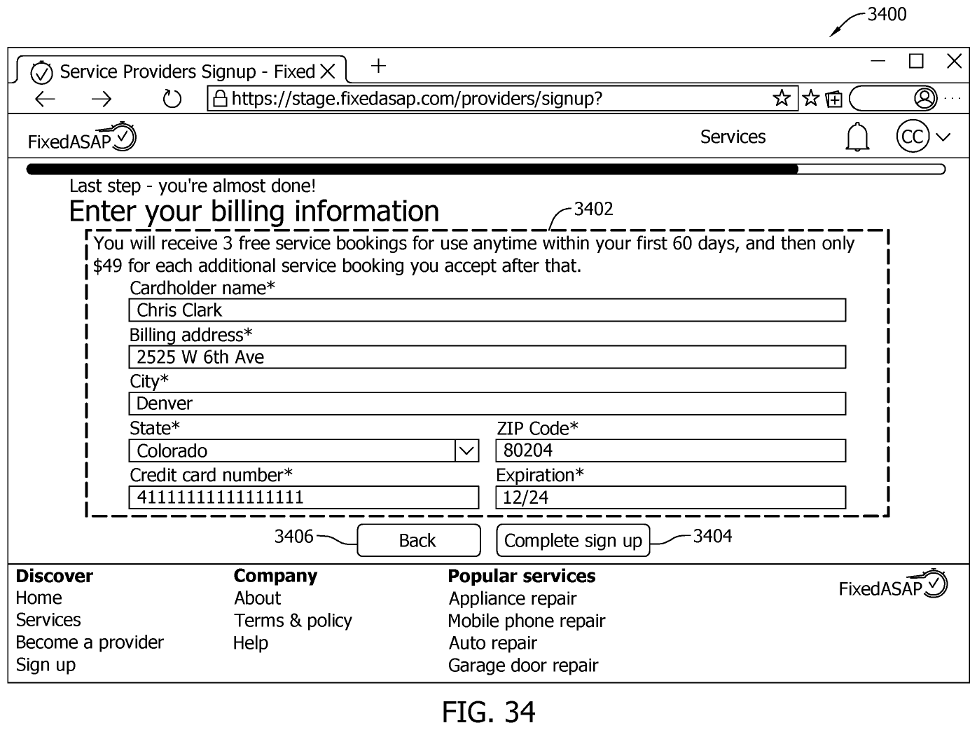

Selecting the next button 3304 may then bring up page 3400 of FIG. 34, which allows service provider 104 to enter credit card information 3402 for billing purposes (see step 2712 of FIG. 27). In some embodiments, system 100 charges service providers 104 a flat fee when service request 118 is booked, and credit card information 3402 entered on page 3400 may be used to bill those charges.

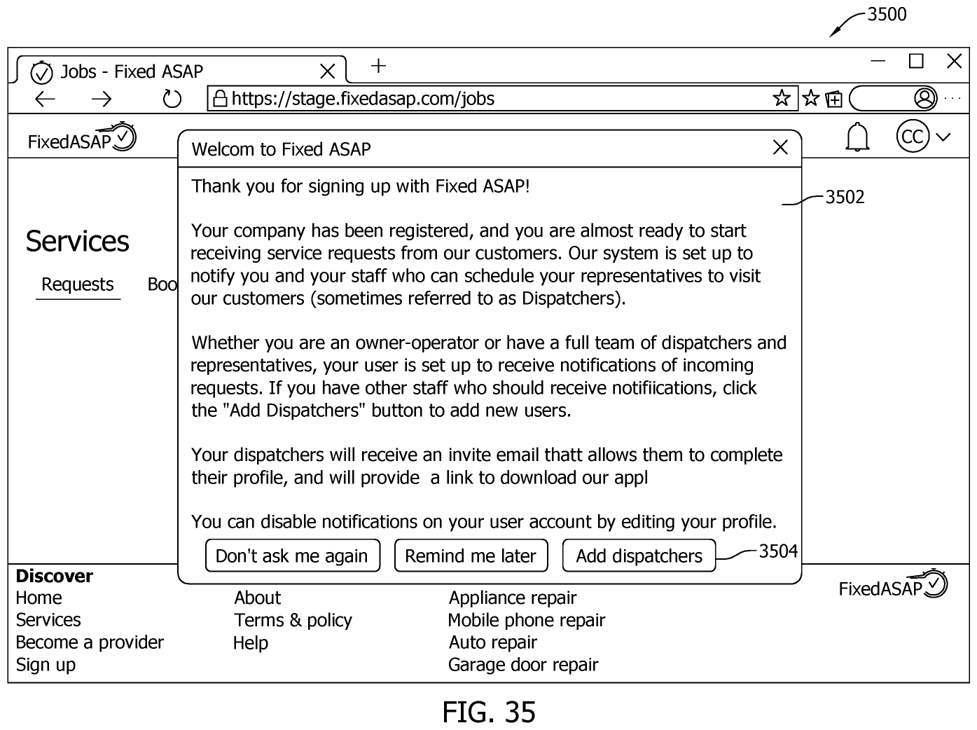

To finalize the sign-up process, service provider 104 may then select button 3404, marked “Complete sign up”, or may instead select a back button 3406 to return to page 3300. Selecting button 3404 may then register this service provider 104 information at server 110 as one of service provider profiles 115, which may record any of the previously discussed information for this service provider 104. After registering at server 110, provider page 3500 (see FIG. 35) may display a welcome screen 3502 which may allow service provider 104 to add one or more dispatchers, using button 3504. Generally, dispatchers are agents or employees of the newly registered service provider 104 that can interact with customers 102 regarding their service requests 118 (see step 2714 of FIG. 27). Adding dispatchers may generally comprise setting up an account for one or more people of the company, typically including their name, email address, etc. Newly added dispatchers may then receive an email notification and sign-up link, which allows the dispatcher to complete the sign-up process and begin receiving notifications regarding service requests 118 that system 100 matches with this particular service provider 104.

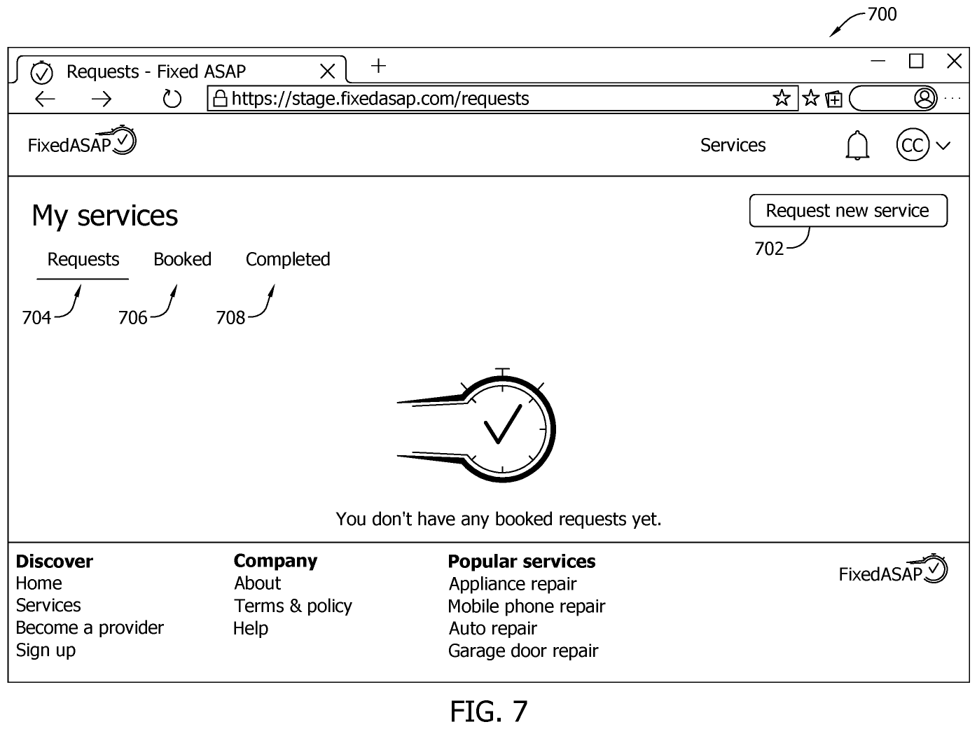

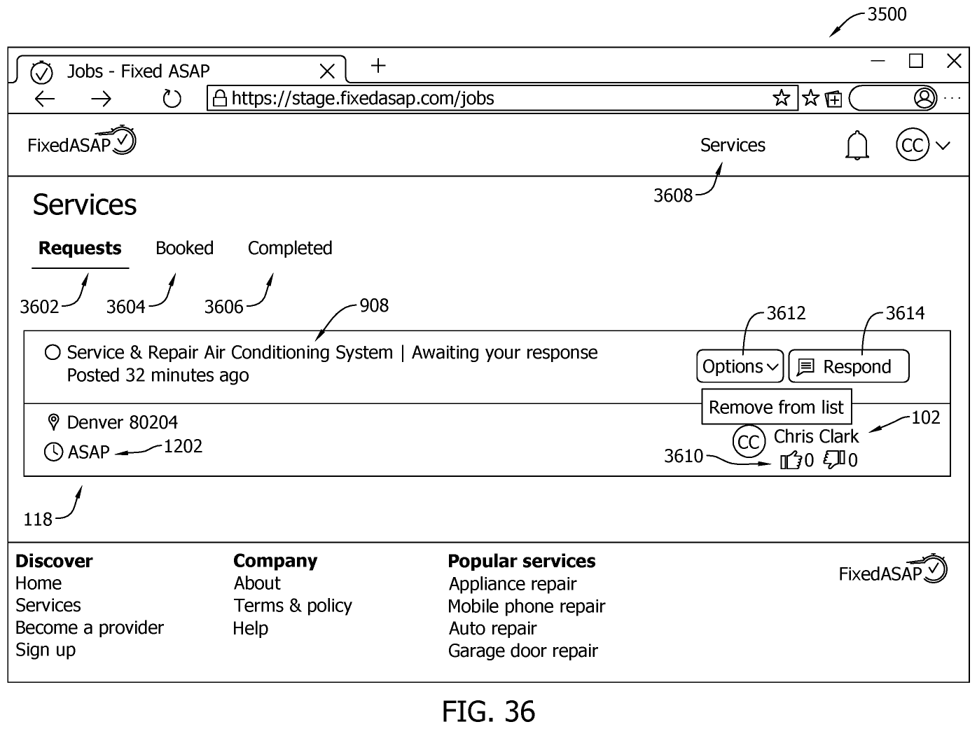

FIG. 36 depicts provider page 3500, which will allow service provider 104 to view various pieces of information, such as service requests 118 from customers 102 that are pending under a requests tab 3602, services requests 118 from customers 102 that are booked under a booked tab 3604, and service requests 118 from customers 102 that have been completed under a completed tab 3606. Similar to customer page 700 (see FIG. 7), provider page 3500 includes a notification 3608 to alert service providers 104 of new communications from customers 102, new service requests 118 for customers 102, etc.

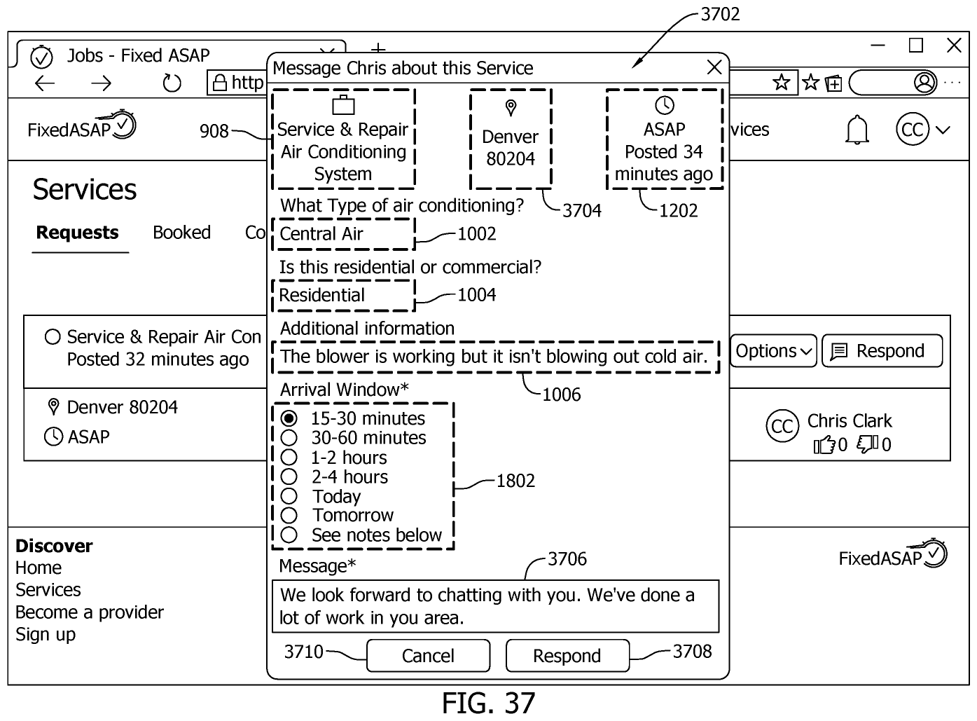

Provider page 3500 depicts service request 118 sent by server 110 for customer 102, which was previously described with respect to the customer workflow (see step 2604 of FIGS. 26-27). Using provider page 3500, service provider may review service request 118, including verifying the area (“Denver 80204” in this example), time frame 1202 requested by customer for service request 118 (“ASAP” in this example), and how long ago customer 102 posted service request 118 (thirty two minutes ago, in this example). Service provider 104 may also review a rating 3610 for this customer 102 (none in this example), and using the information indicated for service request 118, decide whether to respond to customer 102, which is “Chris Clark” in this example. If service provider 104 chooses to not respond, service provider 104 may then select an option 3612 using provider client 130 to “remove from list”, which may hide or otherwise delete service request 118 from provider page 3500. However, if service provider 104 elects to respond to customer 102, service provider 104 may use a respond button 3614 on provider page 3500 to open a response page 3702 depicted in FIG. 37, which allows service provider 104 to respond to service request 118 generated by customer 102.

Response page 3702 may, for example, indicate to service provider 104 more information about service request 118, including service 908 requested by customer 102, a general area 3704 for service address 1402 (e.g., a complete service address 1402 may not be provided to service providers 104 until service request 118 is booked), time frame 1202 for service request 118, etc. Service provider 104 is able to set an arrival window 1802 for this response, which is fifteen to thirty minutes in this example. Service provider 104 is also able to add a message using text window 3706 that will be sent to customer 102 as depicted on communication page 1900 of FIG. 19.

Service provider 104 may then send the response using a respond button 3708, or select a cancel button 3710 which cancels this process (see step 2606 of FIGS. 26-27). Selecting respond button 3708 may generate, for example, the “COEXP Home Services” entry on customer page 700 as depicted in FIG. 18, and communications 1902 entered by “COEXP Home Services” as depicted on communication page 1900 of FIG. 19.

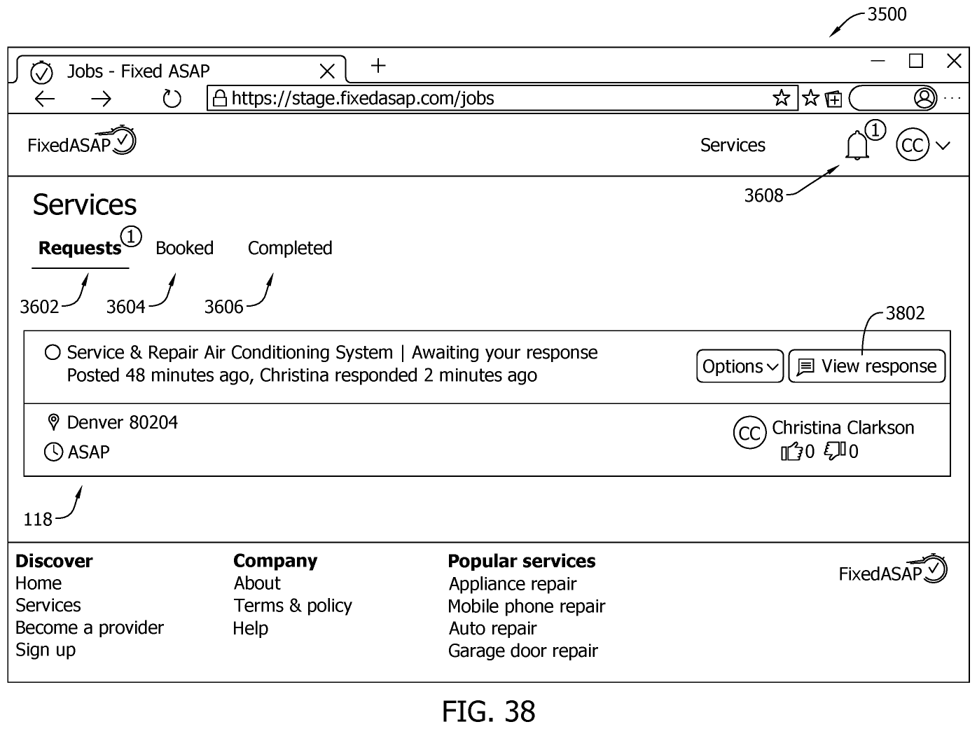

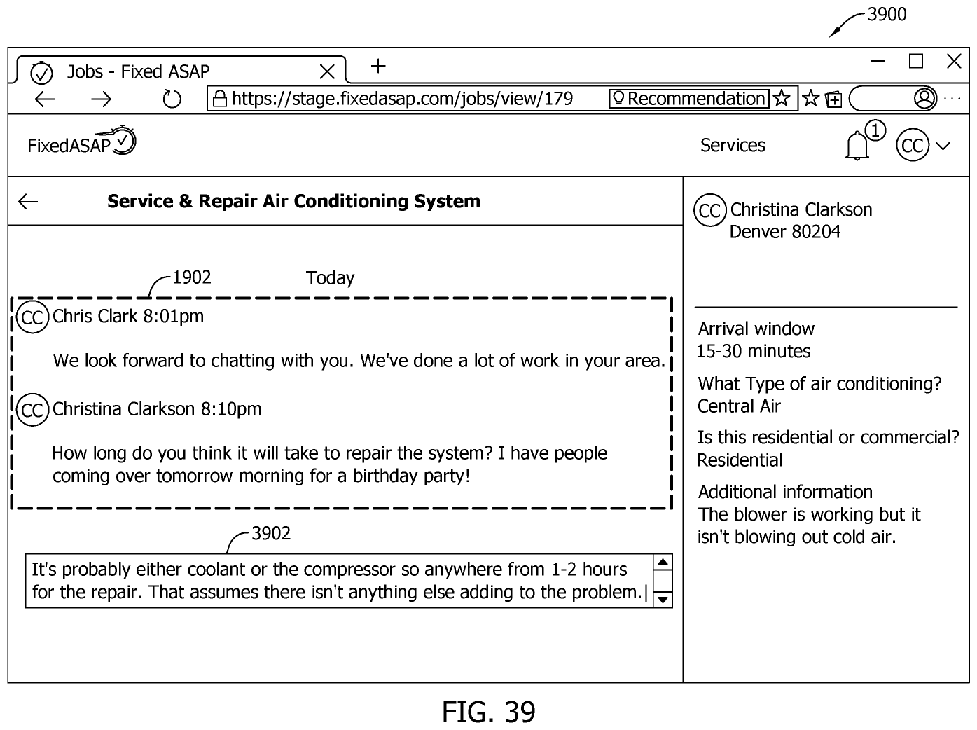

Similar to how communications 1902 were previously described for customers 102 and depicted in FIG. 20, service providers 104 also receive notifications 3608 on provider page 3500 as depicted in FIG. 38. Service providers 104 may also utilize provider page 3500 to communicate with customers 102 regarding service request 118, such as selecting a view response button 3802 in order to open communication page 3900 depicted in FIG. 39, and display communications 1902 between service provider 104 and customers 102. Service provider 104 may also utilize text box 3902 to send messages to customer 102 (see step 2608 of FIGS. 26-27). In some embodiments, communication page 3900 may open automatically if the number of active service requests 118 for service provider 104 is less than a threshold value.

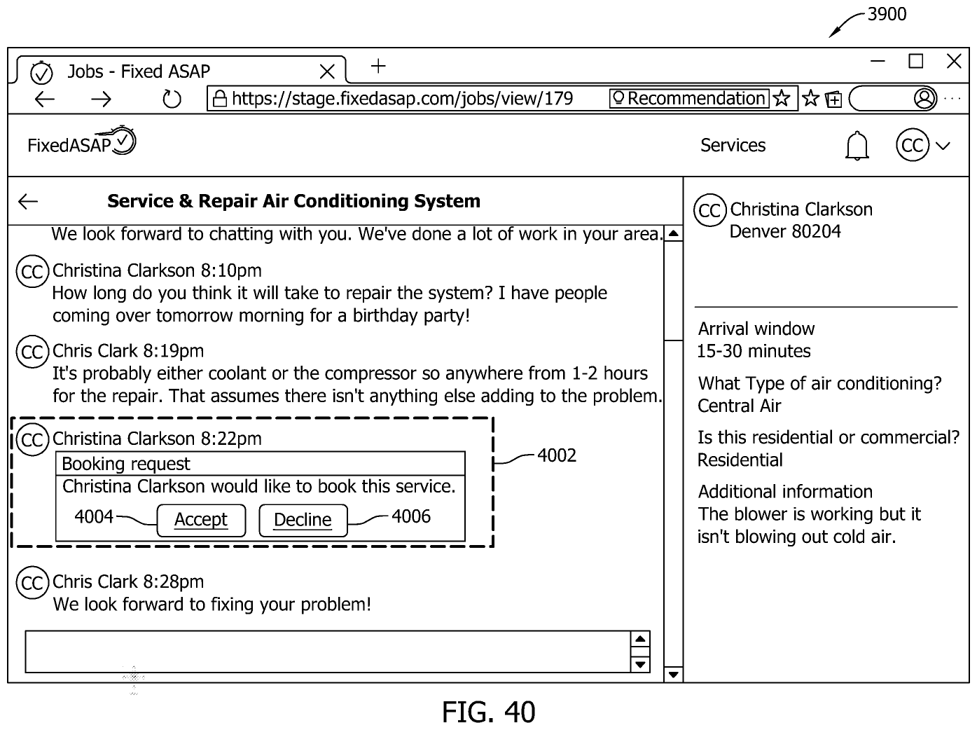

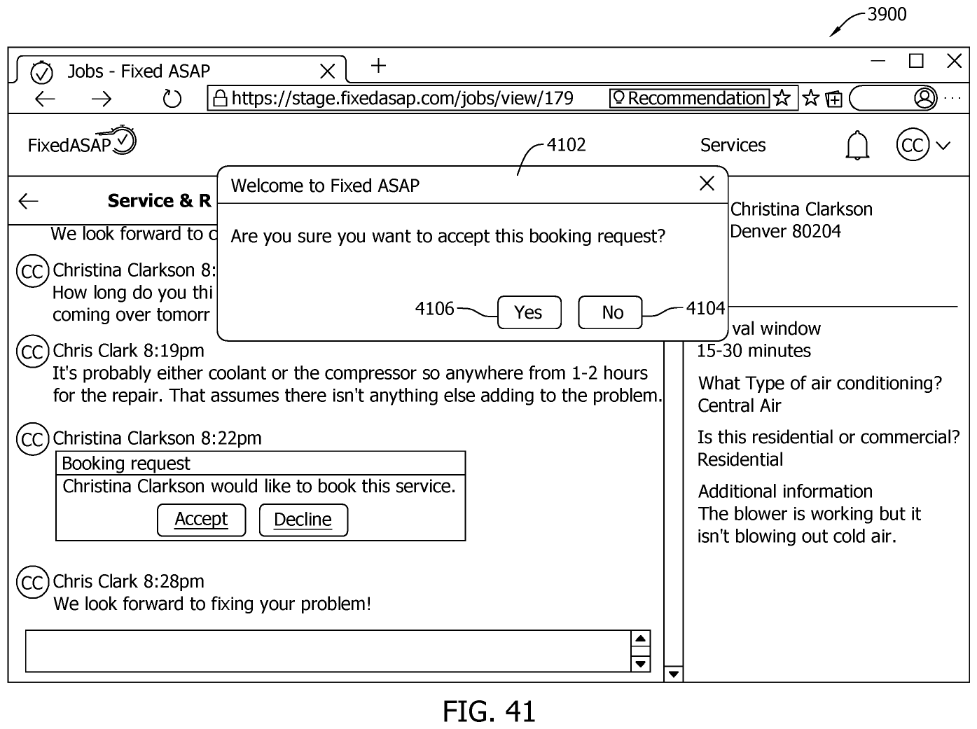

Both service provider 104 and customer 102 may communicate back and forth with each other using communication page 3900 for service provider 104 (see FIG. 40) and communication page 1900 for customer 102 (see FIG. 20) as desired. If customer 102 elects to use service provider 104 for service request 118, customer 102 may generate a booking request (e.g., using request booking button 1906 on communication page 1900), which generates a booking request 4002 at communication page 3900 of service provider 104, as depicted in FIG. 40. If service provider 104 may either decline or accept booking request 4002 from customer 102. Selecting a decline button 4006 declines booking request 4002 from customer 102, while selecting an accept button 4004 on communication page 3900 may bring up a verification window 4102 (see FIG. 41) that allows service provider to either accept this booking via button 4104, marked “Yes”, or decline this booking via button 4106, marked “No”.

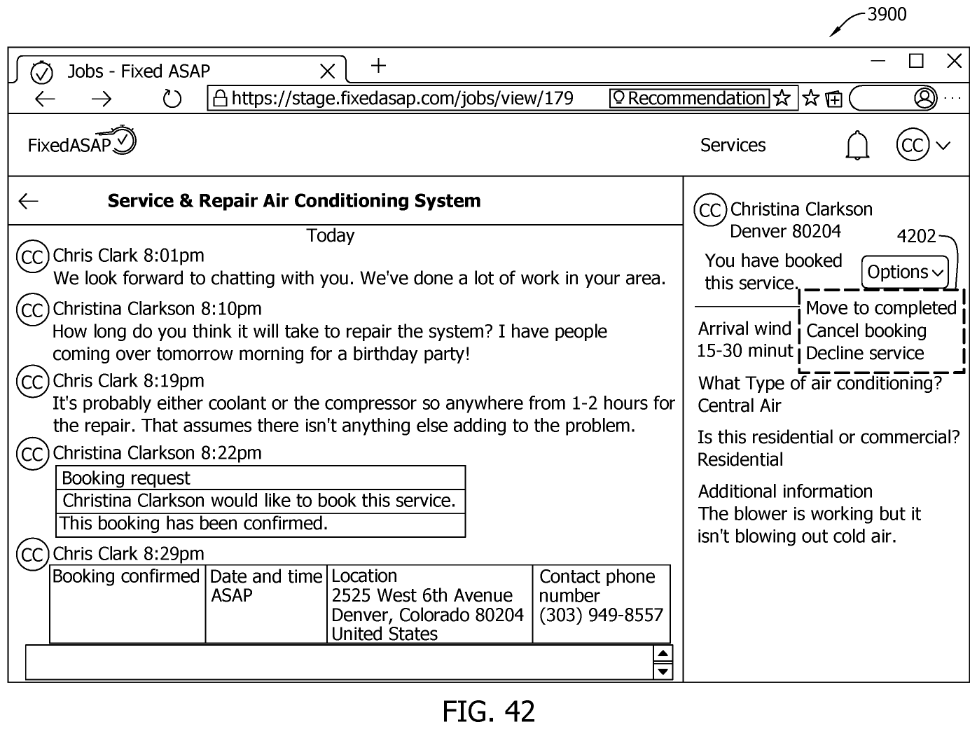

Selecting ‘Yes” via button 4104 accepts booking request 4002 from customer 102 (see step 2612 of FIGS. 26-27) and may return service provider 104 to communication page 3900 as depicted in FIG. 42. Once service provider 104 accepts the booking request 4002, service provider 104 receives the contact information for customer 102 (see step 2614 of FIGS. 26-27). This prevents customer 102 from being contacted by service providers 104 prior to booking service request 118. For example, customer information initially sent or displayed for the service providers 104 with the service request may be redacted (e.g., displaying just a name and area code), and additional information for the customer (e.g., phone number, address, etc.) may be released or displayed for the service provider 104 that books the service request.

From communication page 3900, service provider 104 is provided options 4202 regarding this booked service request 118, including “Move to completed”, “Cancel booking”, and “Decline service”. Options 4202 are also present from provider page 3500, where the booked service request 118 from customer 102 is displayed on provider page 3500 under booked services tab 3604.

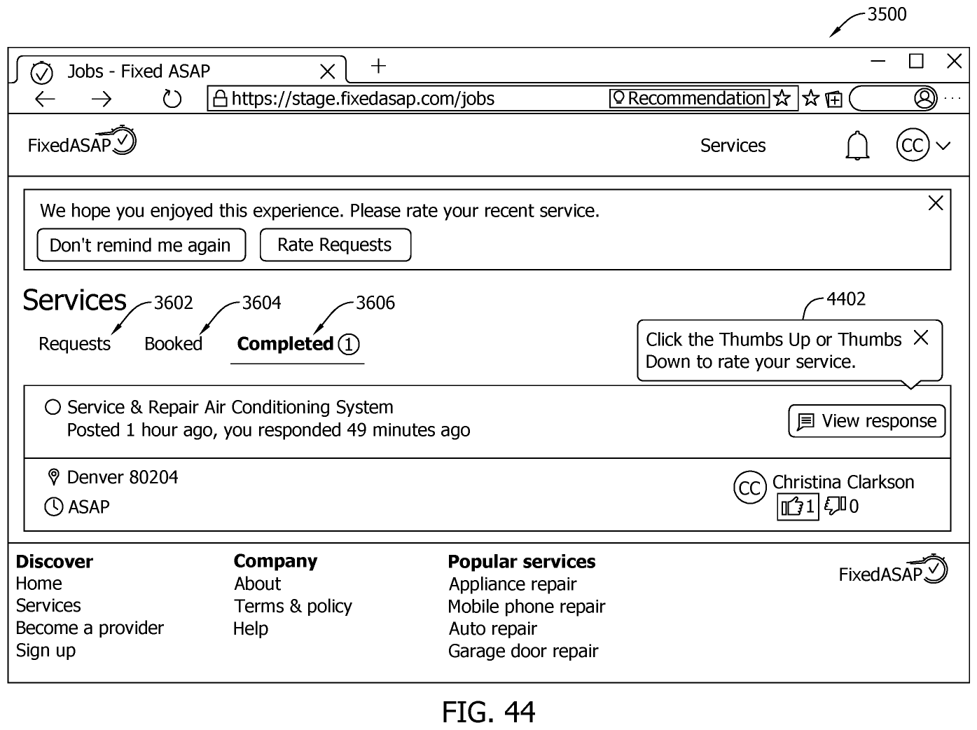

Once service provider 104 marks the service request 118 completed (e.g., using “Move to completed” under options 4202, see step 2616 of FIGS. 26-27), service request 118 is assigned this status and moves to completed service tab 3606, and service provider 104 may receive a notification window 4402 asking if service provider 104 would like to rate this customer 102 as depicted in FIG. 44 (see step 2618 of FIGS. 26-27). In some embodiments, service provider 104 may have an option to refer a company to sign up with system 100 for some type of reward, including a fix or variable fee generated when the company completes a service request 118 with system 100.

### Server Workflow

FIG. 45 is a flow chart of a method 4500 operable by server 110 of system 100 in an illustrative embodiment. Generally, method 4500 describes how server 110 controls how customers 102 and service providers 104 interact with each other.

During a setup and login process for customers 102 (see step 4502 of FIG. 45), server 110 communicates with customer client 120 via data network 140 to interact with customers 102, as generally described previously with respect to step 202 of method 200 (see FIG. 2) of the customer workflow. During a setup and login process for service providers 104 (see step 4504 of FIG. 45), server 110 communicates with provider client 130 via data network 140 to interact with service providers 104, as generally described previously with respect to step 2602 of method 2600 (see FIG. 26) of service provider workflow.

During a process that generates service requests 118 (see step 4506 of FIG. 45), server 110 communicates with customer client 120 via data network 140 to interact with customers 102, as generally described previously with respect to step 204 of method 200 (see FIGS. 2-3) of the customer workflow. For example, when customers 102 select service options 804 when creating service request 118, server 110 may vary what service options 804 are displayed to customer 102 based on what services are registered in system 100 at service provider profiles 115. This may prevent system 100 from generating service requests 118 that cannot be booked by service providers 104.

Server 110 then identifies service providers 104 that can provide the service in service request 118 (see step 4508 of FIG. 45). For instance, server 110 may analyze service provider profiles 115 to identify (1) which service providers 104 previously indicated that they perform the service in service request 118; and/or (2) which service providers 104 have service areas 3006 that include service address 1402, and/or (3) which service providers 104 have notification times 3102 that correspond to when service request 118 was generated. Using one or more of these criteria for matching service request 118 with service providers 104, server 110 determines which of service providers 104 to notify regarding service request 118. Other criteria may be used to match service providers 104 with service requests 118, including any service subcategories, options, etc. For example, some service providers 104 may offer A.C. services for residential customers, but not for commercial customers. This type of filtering prevents system 100 from providing service requests 118 to service providers 104 that specialize in different subcategories of services. In another example, a locksmith may indicate to system 100 that such services are restricted to certain models of vehicles, which would indicate to system 100 that service requests 118 generated by customers 102 regarding locksmith services would not be provided to these particular service providers 104. In another example, service provider 104 may provide repair services for an A.C. system, but not install services for an A.C. system. This preference would be indicated to system 100 in service provider profile 115, thereby allowing system 100 to filter out A.C. service requests 118 that are requesting A.C. installation services.

Server 110 then provides service request 118 to provider clients 130 of the identified service providers 104 (see step 4510), which may then be displayed on provider page 3500 (see FIG. 36) as previously described for step 2604 (see FIG. 27) of the service provider workflow. Various notifications may be generated for service provider 104 and/or customer 102 about service request 118, including emails, SMS messages, audio alerts, etc., which may occur during any type of notification process regarding a change of status for service request 118.

In some embodiments, a delay may be introduced prior to providing service request 118 to some service providers 104. For example, some service providers 104 may receive service request 118 faster than other service providers 104. Such delay may be generated based on any number of factors, including a rating of service provider 104, how long service provider 104 has been registered with system 100, how long service provider 104 has been in business, an average time that service provider 104 takes to respond to service requests 118, a credit tier associated with service provider 104, the average response time for service provider 104, the number of technicians indicated for service provider 104, the hours of operation for service provider 104, etc. In other embodiments, service request 118 may include an expected travel time for service provider 104 that is based on the location of provider client 130.

In response to one or more service providers 104 receiving service request 118, one or more service providers 104 may respond to service request, which is received by server 110 and provided to customer client 120 (see step 4512 of FIG. 45). This activity is described in both the customer workflow (see step 208 of FIG. 2) and service provider workflow (see step 2606 of FIG. 26), and server 110 enables this activity by communicating with both customer client 120 and provider client 130 via data network 140.

Customers 102 may review responses to their service requests 118, and may communicate with service providers 104 regarding their service requests. Server 110 manages these communications by acting as an intermediary between customer client 120 and provider client 130 (see step 4514 of FIG. 45), as previously described with respect to customer workflow (see step 210 of FIG. 2) and service provider workflow (see step 2608 of FIGS. 26-27). For instance, server 110 may analyze and filter communications 1902 between customers 102 and service providers 104, removing information such as phone numbers, email addresses, or other types of secondary communication means that would otherwise allow customers 102 and service providers 104 to bypass system 100 prior to service request 118 being booked through system 100.

Server 110 may then receive a request to book service request 118 from customer client 120 (see step 4516 of FIG. 45), and generate booking request 4002 (see FIG. 40, step 4518 of FIG. 45) at provider client 130 as previously described with respect to the customer workflow (see step 212 of FIGS. 2-3) and the provider workflow (see step 2610 of FIG. 26).

Once server 110 receives acceptance of the booking request from service provider 104 (see step 4520), server 110 provides service provider 104 with the contact information for customer 102 at provider client 130 (see step 4521 of FIG. 45) as previously described with respect to the provider workflow (see step 2614 of FIGS. 26-27). In some embodiments, server 110 may compare arrival window 1802 indicated by service provider 104 with the actual time for service provider 104 to arrive at service address 1402 for service request 118, generating metrics which may be used to modify rating 1804 of service provider 104, modify the delay in providing service request 118 to service provider 104, etc. Any of this functionality may be implemented using location data associated with provider client 130. In another example, server 110 may collect a message (e.g., text message) to the consumer to confirm arrival time and compare it to actual arrival time to potentially modify the performance metrics of service provider 104.

In response to customer 102 marking service request 118 completed (see step 4522), server 110 allows customer 102 to optionally rate service provider 104 utilizing customer client 120 (see step 4524) as previously described with respect to the customer workflow at step 214 and step 216 of FIGS. 2-3, respectfully.

In response to service provider 104 marking service request 118 completed (see step 4526 of FIG. 45), server 110 allows service provider 104 to optionally rate customer 102 utilizing provider client 130 (see step 4528 of FIG. 45) as previously described with respect to the provider workflow at step 2616 and step 2618 of FIGS. 26-27).

System 100 provides a service marketplace engagement and management environment that allows customers 102 and service providers 104 to interact with each other in a controlled and expeditious manner in order to allow customers 102 to quickly and efficiently locate the appropriate service providers 104 to solve their immediate service needs.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope is not limited to those specific embodiments. Rather, the scope is defined by the following claims and any equivalents thereof.

What is claimed is:

1. A system comprising:
a server comprising:
an interface configured to receive, from provider devices, service profiles of maintenance providers, and to receive from a customer device, a service request; and
a controller configured to:
determine, from among the maintenance providers, candidate maintenance providers capable of fulfilling the service request based on the service profiles;
generate a provider page to display data of the service request for a provider device of each of the candidate maintenance providers, and to receive a reply communication to the service request by one or more replying maintenance providers among the candidate maintenance providers;
generate a customer page to display, on the customer device, a list of the one or more replying maintenance providers, each entry of the list including a name, the reply communication, and at least one performance metric of each of the one or more replying maintenance providers;
generate a communication page to exchange one or more messages between the customer device and at least one replying maintenance provider;
receive a selection by the customer device indicating, from among the list of the one or more replying maintenance providers, a selected maintenance provider for performing the service request;
generate a booking request for the selected maintenance provider; and
in response to receiving acceptance of the booking request by the selected maintenance provider, provide customer contact information to the selected maintenance provider to facilitate performance of the service request.

2. The system of claim 1 wherein the controller is configured to:
determine the candidate maintenance providers based on one or more performance metrics of each maintenance provider; and
delay a time of displaying the data of the service request for one or more of the candidate maintenance providers based on the one or more performance metrics of each of the one or more of the candidate maintenance providers.

3. The system of claim 2 wherein the controller is configured to:
modify the one or more performance metrics of the maintenance provider based on user-configured parameters,
wherein the user-configured parameters include one or more of customer rating feedback supplied in response to completing service requests, a number of technicians indicated in the service profile, and a time availability indicated in the service profile.

4. The system of claim 2 wherein the controller is configured to:
modify the one or more performance metrics of the maintenance provider based on automatically tracked parameters,
wherein the automatically tracked parameters include one or more of a length of time the maintenance provider has been providing services, a credit history, an average time to reply to service requests, an average time of arrival to confirmed booking requests, and a historical comparison of estimated arrival times supplied in the reply communication and actual arrival times at confirmed booking requests.

5. The system of claim 1 wherein the controller is configured to:
generate the customer page to display, on the customer device, an interactive window for generating the service request,
wherein the interactive window populates selectable service options based on the service profiles of the maintenance providers, and
wherein each service profile of a maintenance provider includes one or more of a type of service, a geographic area of service, available time of service, and a subcategory of service.

6. The system of claim 1 wherein the controller is configured to:
in response to receiving the acceptance of the booking request by the selected maintenance provider, automatically charge the selected maintenance a booking fee based on billing information in the service profile of the selected maintenance provider.

7. The system of claim 1 wherein:
the at least one performance metric of each of the one or more replying maintenance providers includes one or more of an estimated arrival window supplied in the reply communication, customer rating feedback supplied in response to completing service requests, and service charge information supplied in a corresponding service profile.

8. A method of facilitating requests for maintenance services, the method comprising:
receiving, from provider devices, service profiles of maintenance providers;
receiving, from a customer device, a service request;
determining, from among the maintenance providers, candidate maintenance providers capable of fulfilling the service request based on the service profiles;
generating a provider page to display data of the service request for a provider device of each of the candidate maintenance providers, and to receive a reply communication to the service request by one or more replying maintenance providers among the candidate maintenance providers;
generating a customer page to display, on the customer device, a list of the one or more replying maintenance providers, each entry of the list including a name, the reply communication, and at least one performance metric of each of the one or more replying maintenance providers;
generating a communication page to exchange one or more messages between the customer device and at least one replying maintenance provider;
receiving a selection by the customer device indicating, from among the list of the one or more replying maintenance providers, a selected maintenance provider for performing the service request;
generating a booking request for the selected maintenance provider; and
in response to receiving acceptance of the booking request by the selected maintenance provider, providing customer contact information to the selected maintenance provider to facilitate performance of the service request.

9. The method of claim 8 further comprising:
determining the candidate maintenance providers based on one or more performance metrics of each maintenance provider; and
delaying a time of displaying the data of the service request for one or more of the candidate maintenance providers based on the one or more performance metrics of each of the one or more of the candidate maintenance providers.

10. The method of claim 9 further comprising:
modifying the one or more performance metrics of the maintenance provider based on user-configured parameters,
wherein the user-configured parameters include one or more of customer rating feedback supplied in response to completing service requests, a number of technicians indicated in the service profile, and a time availability indicated in the service profile.

11. The method of claim 9 further comprising:
modifying the one or more performance metrics of the maintenance provider based on automatically tracked parameters,
wherein the automatically tracked parameters include one or more of a length of time the maintenance provider has been providing services, a credit history, an average time to reply to service requests, an average time of arrival to confirmed booking requests, and a historical comparison of estimated arrival times supplied in the reply communication and actual arrival times at confirmed booking requests.

12. The method of claim 8 further comprising:
generating the customer page to display, on the customer device, an interactive window for generating the service request,
wherein the interactive window populates selectable service options based on the service profiles of the maintenance providers, and
wherein each service profile of a maintenance provider includes one or more of a type of service, a geographic area of service, available time of service, and a subcategory of service.

13. The method of claim 8 further comprising:
in response to receiving the acceptance of the booking request by the selected maintenance provider, automatically charging the selected maintenance a booking fee based on billing information in the service profile of the selected maintenance provider.

14. The method of claim 8 wherein:
the at least one performance metric of each of the one or more replying maintenance providers includes one or more of an estimated arrival window supplied in the reply communication, customer rating feedback supplied in response to completing service requests, and service charge information supplied in a corresponding service profile.

15. A non-transitory computer readable medium embodying programmed instructions which, when executed by a processor, are operable for performing a method comprising:
receiving, from provider devices, service profiles of maintenance providers;
receiving, from a customer device, a service request;
determining, from among the maintenance providers, candidate maintenance providers capable of fulfilling the service request based on the service profiles;
generating a provider page to display data of the service request for a provider device of each of the candidate maintenance providers, and to receive a reply communication to the service request by one or more replying maintenance providers among the candidate maintenance providers;
generating a customer page to display, on the customer device, a list of the one or more replying maintenance providers, each entry of the list including a name, the reply communication, and at least one performance metric of each of the one or more replying maintenance providers;
generating a communication page to exchange one or more messages between the customer device and at least one replying maintenance provider;
receiving a selection by the customer device indicating, from among the list of the one or more replying maintenance providers, a selected maintenance provider for performing the service request;
generating a booking request for the selected maintenance provider; and
in response to receiving acceptance of the booking request by the selected maintenance provider, providing customer contact information to the selected maintenance provider to facilitate performance of the service request.

16. The medium of claim 15 wherein the method further comprises:
determining the candidate maintenance providers based on one or more performance metrics of each maintenance provider; and
delaying a time of displaying the data of the service request for one or more of the candidate maintenance providers based on the one or more performance metrics of each of the one or more of the candidate maintenance providers.

17. The medium of claim 16 wherein the method further comprises:
modifying the one or more performance metrics of the maintenance provider based on user-configured parameters,
wherein the user-configured parameters include one or more of customer rating feedback supplied in response to completing service requests, a number of technicians indicated in the service profile, and a time availability indicated in the service profile.

18. The medium of claim 16 wherein the method further comprises:
modifying the one or more performance metrics of the maintenance provider based on automatically tracked parameters,
wherein the automatically tracked parameters include one or more of a length of time the maintenance provider has been providing services, a credit history, an average time to reply to service requests, an average time of arrival to confirmed booking requests, and a historical comparison of estimated arrival times supplied in the reply communication and actual arrival times at confirmed booking requests.

19. The medium of claim 15 wherein the method further comprises:
generating the customer page to display, on the customer device, an interactive window for generating the service request,
wherein the interactive window populates selectable service options based on the service profiles of the maintenance providers, and
wherein each service profile of a maintenance provider includes one or more of a type of service, a geographic area of service, available time of service, and a subcategory of service.

20. The medium of claim 15 wherein the method further comprises:
in response to receiving the acceptance of the booking request by the selected maintenance provider, automatically charging the selected maintenance a booking fee based on billing information in the service profile of the selected maintenance provider.
